(19) United States
(12) Patent Application Publication
(10) Pub. No.: US 2004/0243285 A1
(43) Pub. Date: Dec. 2, 2004

(54) Vehicle monitoring and reporting system

(76) Inventor: Manickam A. Gounder, Olive Branch, MS (US)

Correspondence Address: H Roy Berkenstock, Wyatt Tarrant & Combs, Suite 800, 1715 Aaron Brenner Drive, Memphis, TN, 38120-4367, US

(21) Appl. No.: 10/493,623

(22) PCT Filed: Sep. 29, 2003
(86) PCT No.: PCT/US03/30673

Related U.S. Application Data
(60) Provisional application No. 60/414,028, filed on Sep. 27, 2002.

(51) Int. Cl. G06F 17/00

(52) U.S. Cl. 701/1; 701/35; 701/200

(57) ABSTRACT

The present invention is directed to a vehicle monitoring and reporting system that includes a vehicular subsystem attached (or at least attachable) to a motor vehicle, a non-vehicular subsystem that typically remains separate and distinct from the motor vehicle, a communication module for transmitting data between the vehicular and non-vehicular subsystems. The vehicular subsystem generally includes a computer, a first data card reader that is interconnected with the computer, and a plurality of data input devices that are also interconnected with the computer. The non-vehicular subsystem has a central processing unit and a second data card reader that is interconnected with the central processing unit. Further, the vehicle monitoring and reporting system of the present invention includes at least one data card disposable in the first and second data card readers. These data cards are preferably operator-specific, as well as being capable of having data read from and written to the same.

### CROSS-REFERENCE TO RELATED APPLICATIONS

This application claims priority under 35 USC 119(e) to U.S. Provisional Application No. 60/414,028 entitled “Vehicle Monitoring and Reporting System” that was filed on Sep. 27, 2002, which is incorporated herein by reference in its entirety.

### STATEMENT REGARDING FEDERALLY SPONSORED RESEARCH/DEVELOPMENT

Not applicable

### REFERENCE TO A “MICROFICHE APPENDIX”

Not applicable

### BACKGROUND OF THE INVENTION

Many companies today employ field representatives to provide services to remote locations. The field representatives spend a significant portion of their work time driving from one job site to another. These companies are faced with the challenge of making the most economical use of the field representatives' valuable work time by minimizing their travel time between job assignments. Thus, it may be desirable to monitor the field representatives' work time in order to determine how efficiently they are being utilized. Information gained from monitoring may provide guidance on how to improve the use of their time. However, because field representatives spend most of their time at remote locations away from direct observation, the monitoring of their movements may be difficult to accomplish.

One way to monitor field representatives or vehicle operators is to merely equip fleet vehicles with global positioning system (GPS) equipment. GPS has been utilized to report a vehicle's positioning to a central office. One problem faced with the use of GPS in fleet vehicles is the difficulty associated with manually processing data supplied by the GPS units to evaluate work performance as well as providing guidance on how to make the most economical use of field representatives. Moreover, during the course of a working day, a GPS system associated with a fleet vehicle may generate large quantities of positional data. Managing and generating reports relating to this collected data has become significantly labor intensive. Moreover, mere collection of GPS data fails to provide users with the desired information for generating various reports that may be desired and/or required in the particular industry of use. Indeed, more times than not, this significant amount of GPS data is processed manually. Not only is the manual processing of the GPS data time-consuming, but it is susceptible to human error in one or both entry and processing.

With regard to the commercial transportation (e.g., trucking) industry, adequate management and monitoring of vehicle mileages, driver's duty logs, driving routes and tracking of current positions of the vehicles is quite desirable to promote cost effective fleet management. Moreover, the government and/or employers typically require that reports be submitted regarding total miles driven in a state, driver's time, fuel added in a state, driver's hours of service, and the like. The accuracy of the information in these reports has traditionally been erratic due, at least in part, to the tracking methods employed in collecting the relevant vehicular information. This inaccuracy of vehicular data (and thus the reports generated therefrom) may lead to the inaccurate calculations of taxes and/or loss of revenue. Since a significant portion of the commercial transportation industry generally estimates this information or utilizes manual entry of this information, conventional monitoring and reporting systems have been both time consuming and prone to manual errors.

Accordingly, it is an object of the present invention to provide a vehicle monitoring and reporting system that enables cost-effective fleet management. It is another object of the invention to provide a vehicle monitoring and reporting system that facilitates compliance with state and federal tax requirements (e.g., in the filing of tax returns). Still another object of the invention is to provide a system that at least generally enhances logging and monitoring of vehicular trip information. Another related object is to provide a vehicle monitoring and reporting system that at least generally assists in generating reports that are in compliance with the International Fuel Tax Agreement (IFTA). Yet another object of the present invention is to provide a system that stores and reports driver-specific data, and/or traveled routes of a vehicle.

### SUMMARY OF THE INVENTION

The above-mentioned objectives, as well as other objectives, may be met by the present invention, which is directed to a vehicle monitoring and reporting system that may at least generally be characterized as including a modular hardware system and at least some software support. This vehicle monitoring and reporting system generally includes a vehicular subsystem (e.g., that which is to be interconnected with a motor vehicle) and a non-vehicular subsystem (e.g., that which is to be used at a station/office). In one characterization, the vehicle monitoring and reporting system of the present invention may be utilized for at least one of logging, tracking, monitoring, and reporting information pertaining to motor vehicles such as commercial trucks or other fleet vehicles (e.g., in traveling sales/distribution operations). Examples of information that may be provided using the vehicle monitoring and reporting system of the present invention may include one or more of information relating to global location (optionally compared to a selected route), vehicular velocity, miles/mileage, travel direction, fuel purchase, and event times, as well as other desired parameters of the vehicle.

In a preferred embodiment, the vehicular subsystem of the vehicle monitoring and reporting system includes a plurality of components for providing information relating to the motor vehicle (including information relating to the vehicle operator). These components include a GPS receiver, a vehicle odometer sensor or electronic control module (ECM), and a manual input device such as one or more of a keyboard, mouse, paddle/joystick and the like. The information that is provided by the three components may be stored in an appropriate memory of a computer of vehicular subsystem and/or may be transmitted by a communication module between the vehicular subsystem and the non-vehicular subsystem associated with the present invention. This vehicle information may be transmitted/collected on what may be characterized as regular sampling intervals (e.g., every 5 minutes) and/or intermittent (or irregular) sampling intervals. In other words, the vehicle monitoring and reporting system of the present invention may be configured to send/receive data at a variety of appropriate time periods between the vehicular subsystem and the non-vehicular subsystem (e.g., depending on the desired specifications) In one embodiment, these sampling intervals are stored in one or more appropriate memory storage devices associated with the vehicular and/or non-vehicular subsystems of the invention.

In a preferred aspect of the invention, vehicle information may be downloaded to an operator/user-specific data card or the like (e.g., during and/or at the end of the driver's duty and/or at the conclusion of a vehicle trip). As stated above, this vehicle information may also or alternatively be transmitted through the communication module of the system (preferably in substantially real time or at regular intervals) to one or more of a centralized base station (e.g., CPU) of the system, a branch (or satellite) station of the system, and a customer station (e.g., customer desktop). Accordingly, it may be said that this communication module of the vehicle monitoring and reporting system generally enables vehicle-/operator-related data to be conveyed between the non-vehicular subsystem (e.g., the base station) and the vehicular subsystem (e.g., the motor vehicle). This communication module may be any appropriate module that is capable of sending and receiving data. Examples of appropriate communication modules include, but are limited to, a two way pager/GSM (Global System for Mobile Communications) system and a cellular/satellite communication system. The data that is transmitted from the vehicular subsystem (and/or the data card engaged therewith) to the non-vehicular component is preferably coded for security. Accordingly, software associated with the non-vehicular component preferably includes a decoding provision to process the received data.

The above-mentioned operator-specific data card associated with the vehicle monitoring and reporting system may provide a number of beneficial features. For instance, the data card may serve as vehicle operator's time card. In other words, the data card may be used to at least generally facilitate monitoring a duty status of one or more drivers (e.g., hours of service (HOS) during a given month or along a certain trip). As another benefit, the data card may serve as a backup memory storage device of sorts for information associated with that particular operator/vehicle. So, for instance, in an untimely event that an attempt to transmit vehicle/trip information via the communication module of the system to an appropriate recipient (e.g., the base station, remote station, and/or a customer desktop) fails or is otherwise deficient, that information may be stored on the data card to be resent (via the communication module) at a later time and/or downloaded directly from the data card upon interconnecting the same with an appropriate processing unit of the non-vehicular subsystem.

As a further description of the data card associated with the vehicle monitoring and reporting system, a vehicle operator may be provided with such a data card that has been configured to include operator-specific information (e.g., driver's license number, employee number, etc.). The system is generally configured to accommodate data cards of differing memory storage capabilities to store operator/vehicular trip data for trips of up to one month or more. In addition to the operator-specific card, the onboard computer of the vehicular subsystem may include a built-in memory for storage of information of up to a one-month period or longer. In addition, the non-vehicular subsystem (e.g., the base station) will typically have an appropriate memory storage device interconnected therewith (e.g., as a central information repository). So, at the end of the trip, for example, information (e.g., formatted raw data) from the data card may be downloaded into an appropriate database associated with the non-vehicular subsystem (e.g., through a data card reader/writer).

The vehicular subsystem associated with the present invention may include various other refinements. For instance, in one embodiment, the vehicular subsystem may have an onboard printer to enable an operator to receive or generate a hardcopy printout of vehicle-/operator-related data (e.g., duty status for a set period or a trip progress report). In another embodiment, the vehicular subsystem may include an appropriate display screen (e.g., monitor).

In addition to the hardware components associated with the invention, the vehicle monitoring and reporting system of the present invention generally includes software support (e.g., customer report generating software). This software support is preferably at least generally found in a central processing unit associated with the non-vehicular subsystem. However, some embodiments have appropriate software support included in the vehicular subsystem. As an example, the system, in at least one embodiment, may be said to be capable of receiving and reading raw data, updating an associated database based on that raw data, and generating various selected reports (e.g., for management and/or customers). In another embodiment, the raw data relating to the motor vehicle and/or the operator of the same may be sent to a website (e.g., where the data is processed and reports may be generated). In the case where web-based data reporting is desired, the website may include appropriate software to accomplish the desired reporting functions. Incidentally, the website may be hosted by any appropriate entity including a customer, a supplier, and/or a third party database administrator.

As stated above, the transmitted information may be, in at least one embodiment, routed to a specified Internet website. Once the data reaches the website, the raw data may processed to be accessed in the form of reports by a desired viewer (e.g., employer or customer). Accordingly, the vehicle monitoring and reporting system of the present invention may enable raw data to be at least one of manually processed by a customer/user, processed by software found in the central processing unit of the base station, and processed by software associated with an appropriate website. In the case where it is desirable to have data/reports accessible via the Internet, the invention may include provisions to enable vehicle operators, management, customers, and/or government authorities to view the data/reports securely using one or more appropriate access codes. In other words, the web page may be secured by setting up appropriate user access authorization measures. Accordingly, retrieving the data/reports preferably requires a security password or data download through a dedicated web page. The web page (e.g., the associated software and/or host thereof) may then decode the data before posting it on the particular Internet site for the driver, company, and/or customer to access.

Still with regard to web-based applications of the invention, in the event that transmissions of data via the communication module fail (e.g., when the motor vehicle is out of range of the communication network), the system may be configured so that the vehicle/operator data may be stored in the data card and/or the onboard memory. Moreover, when the motor vehicle returns to a communication coverage zone that enables such data to be transmitted, the system may be configured so that the data may be transmitted to the website (e.g., so that no data is lost).

In the case of the vehicle monitoring and reporting system of the present invention being utilized in the context of the commercial trucking industry, and by way of example, the data and/or report(s) generated may relate to one or more of vehicle/operator management, operator (e.g., driver) logs, operator duty status, communication module function/activity. More particularly, examples of desired reports that may be generated using the vehicle monitoring and reporting system of the present invention may relate to daily detailed driver's logs, driver's log summaries, fuel purchase (e.g., frequency and quantity), mapping (e.g., routing), mileage, driver's duty start and end times, state/federal regulation compliance, taxation, frequency of data communications and/or transmissions to/from the motor vehicle.

In another aspect of the present invention, the vehicle monitoring and reporting system may include a state line border crossing detector (e.g., that utilizes data from the GPS receiver). In such an embodiment equipped with a state line border crossing detector, the vehicle monitoring and reporting system preferably includes global position data for all the state line borders and a software algorithm that is capable of comparing GPS data to the global position data of the database. So, for example, each time a new coordinate is received, the vehicle monitoring and reporting system is utilized to analyze the position of the motor vehicle relative to one or more state borders. Once a crossing of a state border is detected, vehicular data including position, miles traveled within a particular state, and time spent within a particular state is stored (one or both onboard and at the non-vehicular subsystem) and/or transmitted to the non-vehicular subsystem. In the case that it is desirable to have software support of the associated website accomplish this state border crossing feature, the vehicular data may be provided to the website and processed to provide the above-described vehicular data. Of course, the frequency at which the GPS data is collected and analyzed relative to the global position data may impact the accuracy of the resultant data/reports. In other words, the more frequently the GPS data is collected, the more accurate the resulting vehicular data relating to state border crossing.

While the present invention is generally described herein with regard to its application to the commercial trucking industry, it will be understood that the functionality of the present invention is not restricted to the commercial trucking industry. In other words, the vehicle monitoring and reporting system of the present invention may have other appropriate vehicular applications, such as for ships and tows, trains, and distribution/sales vehicles.

### BRIEF DESCRIPTION OF THE DRAWINGS

FIG. 1 is a block diagram of an arrangement that includes a vehicle monitoring and reporting system of the invention.

FIG. 2 is a block diagram of information/data flow.

FIG. 3 is a block diagram showing an embodiment of a vehicle monitoring and reporting system.

FIGS. 4A-F are wiring diagrams for hardware associated with a vehicle monitoring and reporting system.

FIG. 5 is a layout of a printed circuit board.

FIG. 6 is a block diagram of a GPS component.

FIG. 7 is a block diagram of a two-way pager component.

FIG. 8 is a block diagram of a two-way satellite module.

FIGS. 9A and 9B are block diagrams illustrating a software main flow diagram for a vehicle monitoring and reporting system employed in a truck fleet.

FIGS. 10A-T are block diagrams illustrating an operational flow sequence of steps for vehicle monitoring and reporting system.

FIG. 11 is a pictorial of a control box associated with a vehicle monitoring and reporting system.

FIG. 12 is a diagram of a keypad layout.

FIG. 13 is a block diagram of an application of a vehicle monitoring and reporting system.

### DETAILED DESCRIPTION OF THE INVENTION

Preface

As mentioned above, the vehicle monitoring and reporting system of the present invention may be employed for use with regard to any of a number of appropriate vehicles. This vehicle monitoring and reporting system is at least generally capable of providing vehicular operational/status data for management, governmental authorities, and/or drivers of those vehicles. Again, this system may be programmed for provide a number of processing and reporting features including reporting relating to taxation, driver duty status, daily driver logs, fleet operations, and others.

In one characterization, this vehicle monitoring and reporting system may be said to be configured to electronically capture relevant data regarding the driver and the vehicle from the beginning to the end of trip. A preferred embodiment of the system is capable of collecting and storing the following data in the storage components of system (including the data card) and also capable of transmitting data (e.g., pre-selected data points) to appropriate recipients such as one or more of a dispatcher, government tax station, border monitor and the like.

The vehicle monitoring and reporting system of the invention generally allow data to be input into the system via the GPS receiver, the onboard manual input device, and the vehicle odometer sensor/electronic control module (ECM). Accordingly, the following data inputs may be provided to the system: date stamps; time stamps; vehicle IDs (e.g., “VIN” numbers or fleet numbers); names and/or driver license numbers of operators; latitude and longitude of the vehicles; odometer readings; routing; tracking; trip/operator start and finish times; fueling information (e.g., type, quantity, frequency, price, location); and vehicular speed.

This vehicle monitoring and reporting system utilizes an appropriate communication module (such as a two-way pager/GSM or cellular/satellite communication module) to transmit data between the vehicular and non-vehicular subsystems, preferably at each programmable time interval. With regard to the non-vehicular subsystem, a remotely located base station PC equipped with an appropriate telecommunication device receives data from at least one vehicle and stores the information in the associated database. This raw data may then be downloaded into the Internet. As stated above, the user of this vehicle monitoring and reporting system has several choices of how and where the data is stored. With data transferred to Internet, anyone with authorization may be able to determine the location of a vehicle (and/or its direction of travel) at any given point in time.

While the data card of the vehicle monitoring and reporting system may exhibit any of a number of appropriate storage capabilities, a preferred embodiment of the data card can store at least 128 k of data provided (at least indirectly) from one or more of the GPS receiver, the onboard manual input device, and the vehicle odometer sensor/electronic control module (ECM). These data cards are preferably operator-specific. That is, each driver/operator preferably has (or is assigned) his/her own data card. Accordingly, each data card is preferably coded to include information specific to that particular driver (e.g., driver's license number, social security number, driving record, driver's logs, and the like). Moreover, the data card may be programmed to enable an operator to use the same as a fuel card to make fuel purchases.

Using a particular trip (or delivery assignment) as an example, trip and/or operator data for that particular trip may be written to and/or read from the operator's data card via a data card reader/writer associated with the CPU of the non-vehicular subsystem (e.g., the base station) prior to the beginning of the trip. Once the operator has entered the truck, the operator will insert his data card into a data card reader/writer that is installed in the truck. Once the trip begins, the vehicular subsystem (via the computer and memory associated therewith) will collect and store data relating to the trip (preferably on a predetermined time interval. Moreover, the communication module (e.g., satellite/cellular phone module or two-way pager/GSM module) enables the data relating to the trip to be transferred between the vehicle and the base station (again, preferably at predetermined time intervals).

Description of the Illustrated Embodiments

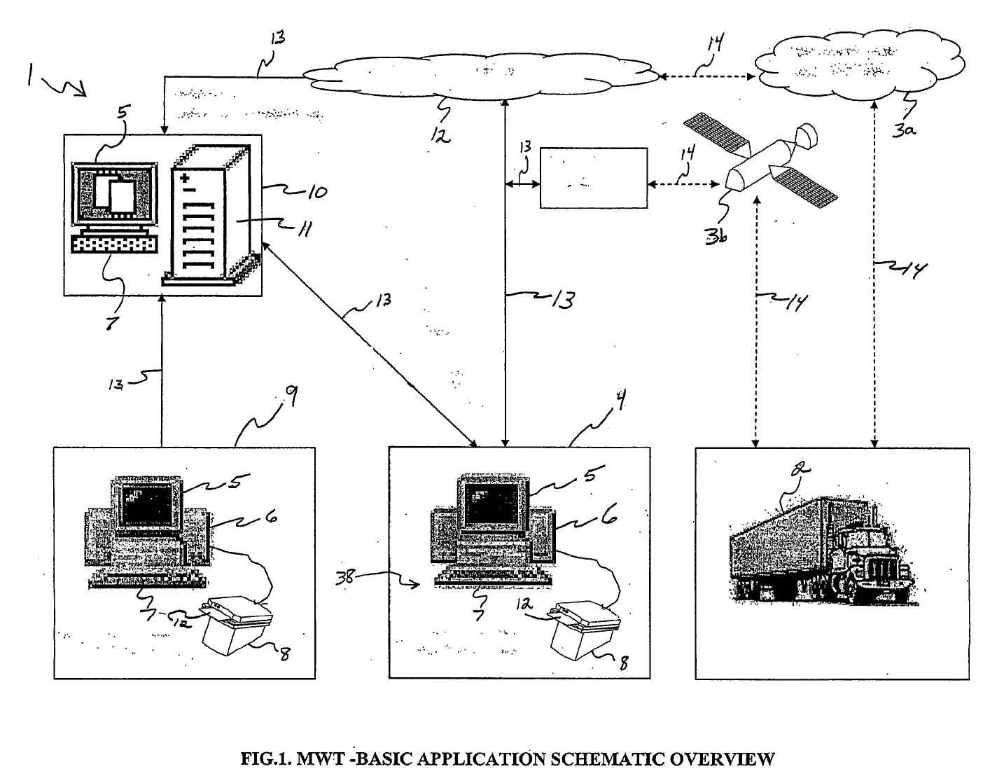

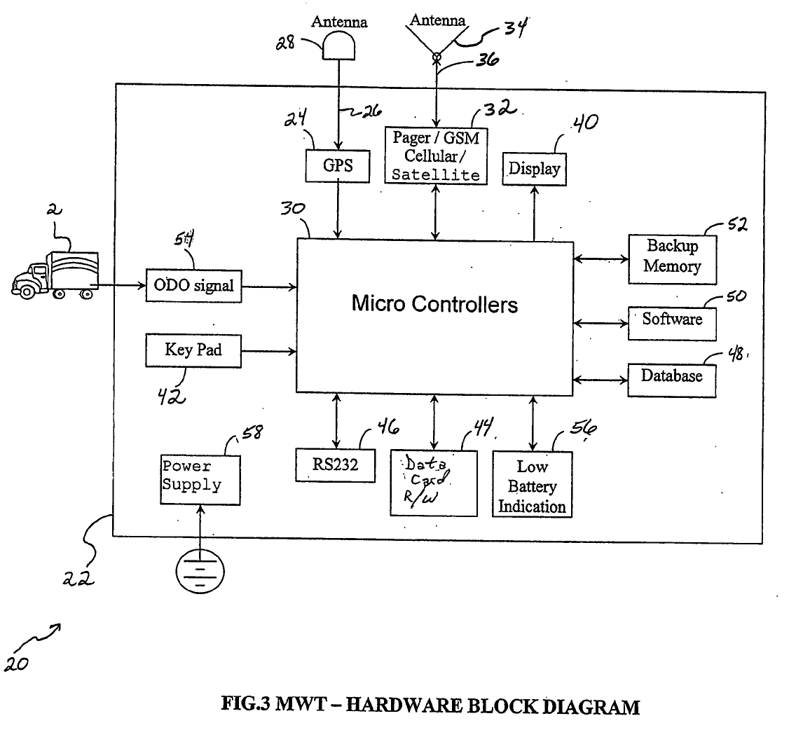

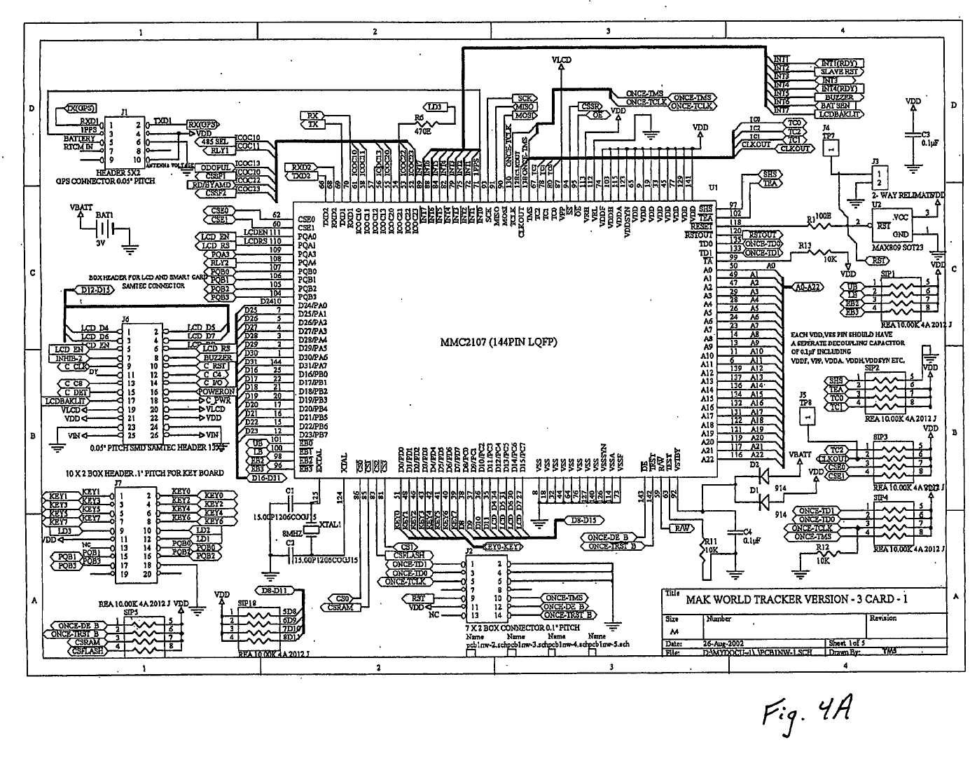

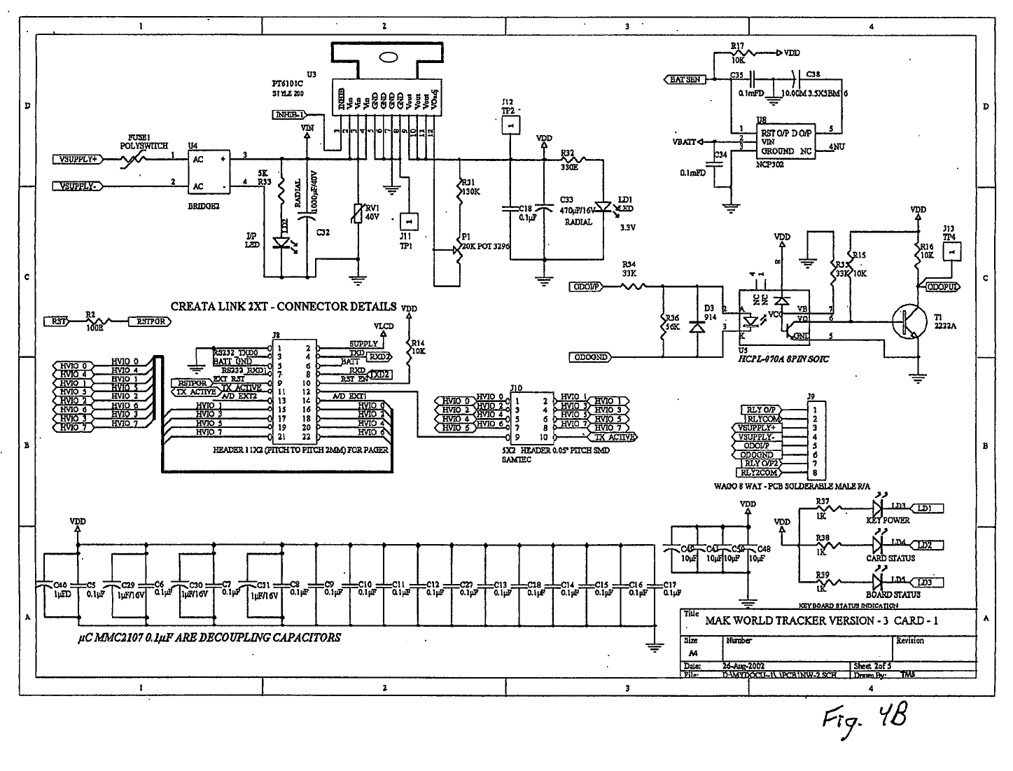

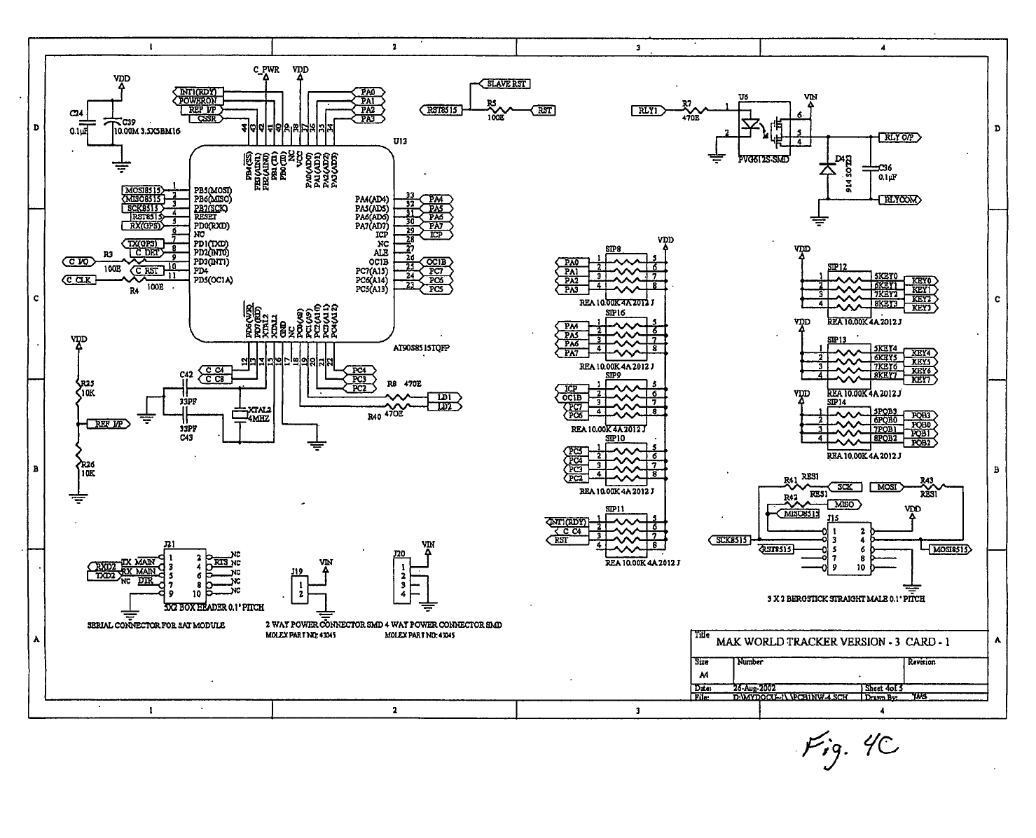

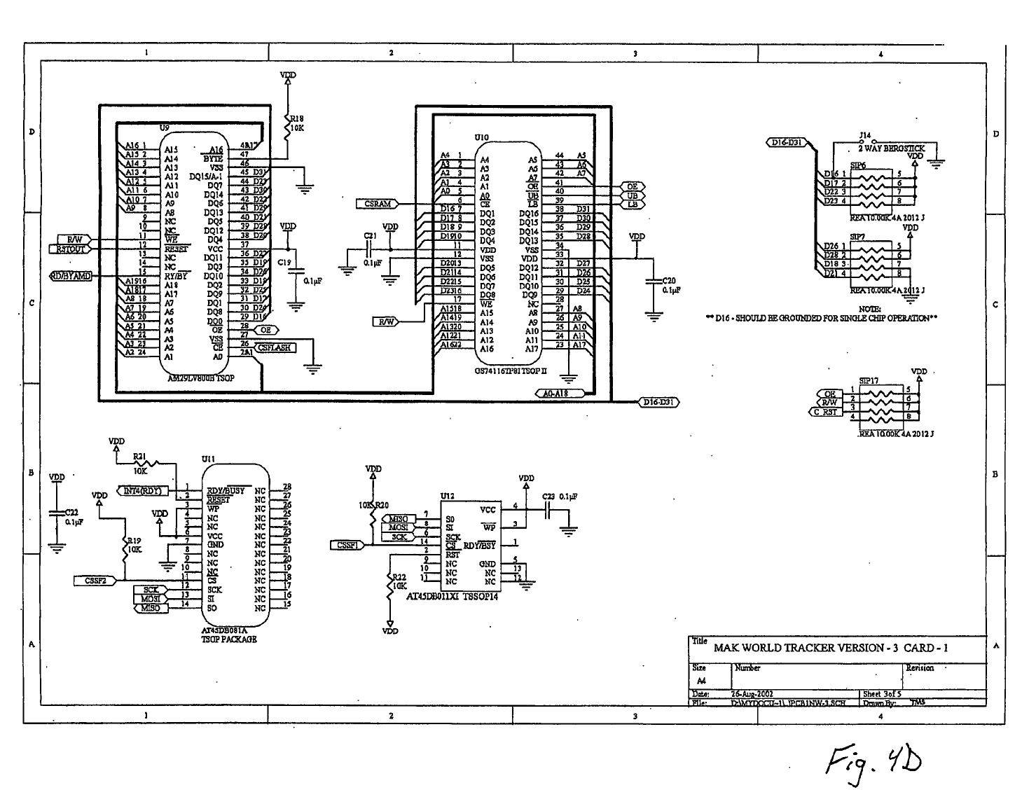

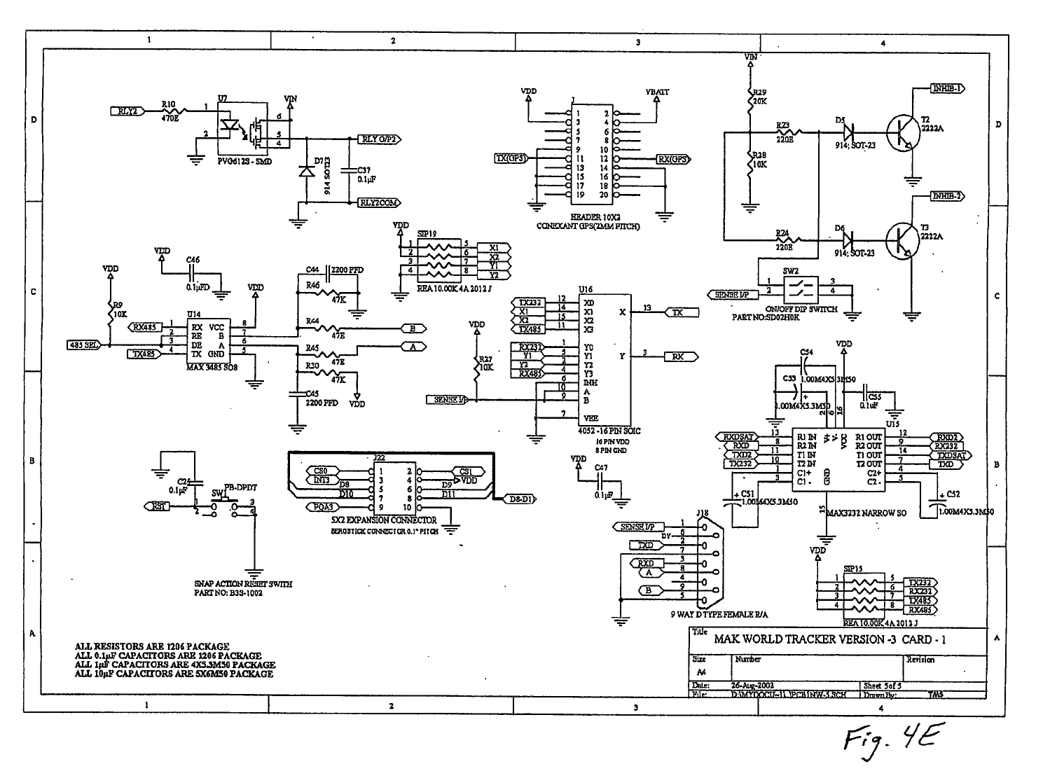

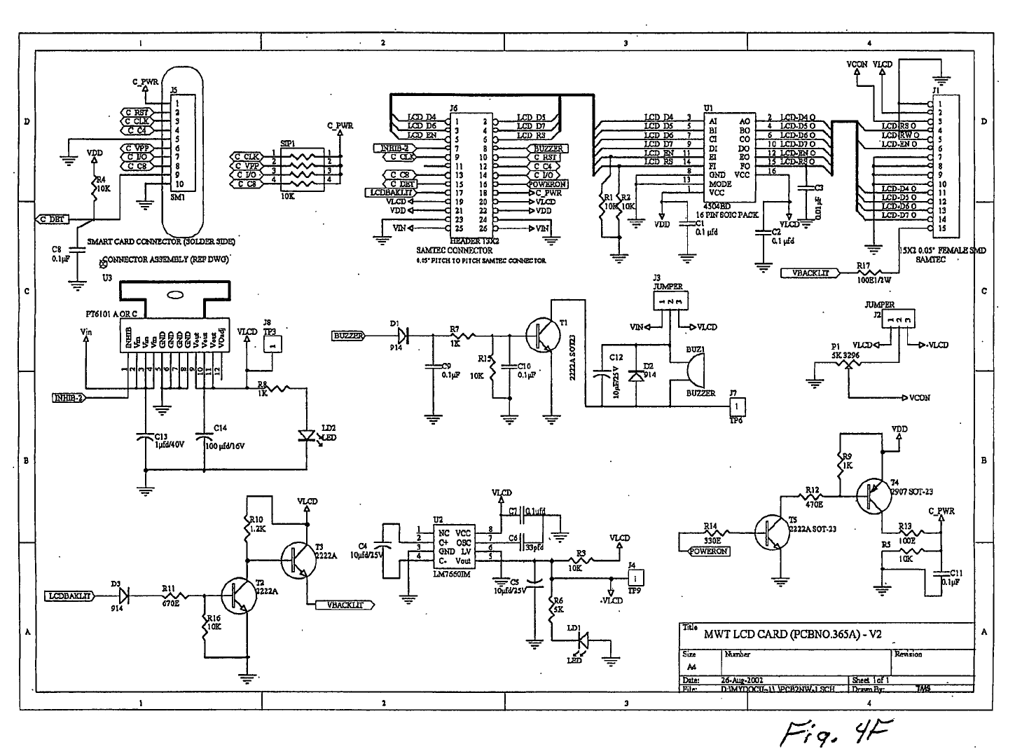

The present invention will now be described in relation to the accompanying drawings, which at least assist in illustrating the various pertinent features thereof. FIG. 1 illustrates an arrangement 1 that includes a vehicle monitoring and reporting system 20 (FIG. 3). A vehicular subsystem 22 (FIG. 3) of the vehicle monitoring and reporting system 20 is installed in the truck 2 and is capable of at least transmitting (and preferably both transmitting and receiving) data, preferably at predetermined regular intervals (e.g., every 5 minutes). These transmissions are preferably accomplished or at least generally facilitated using an appropriate communication module 3. While a number of appropriate communication modules may be employed in the vehicle monitoring and reporting system 20, the communication module 3 is preferably a two-way pager/GSM system 3a or a telephone/satellite system 3b. Further, data that is conveyed using the telephone/satellite system 3b is shown as being routed through an appropriate ground station 15.

The arrangement 1 also includes a base station 4 that includes non-vehicular subsystem 38 of the vehicle monitoring and reporting system 20 that is shown as including a display (e.g., computer monitor) 5, a central processing unit (CPU) 6, a keyboard 7, and data card reader/writer 8. This non-vehicular subsystem is generally configured to send and receive data (via the communication module 3) to a portion of the vehicle monitoring and reporting system 20 that is connected to the truck 2. In addition, this non-vehicular subsystem 38 associated with the base station 4 may be said to be capable of providing trip data (e.g., data relating to how a vehicle is progressing on a delivery route) and/or vehicle status information to a remote station (e.g., a customer's location, a truck stop, and/or a satellite location that includes another non-vehicular subsystem) 9. While this remote station 9 is shown as including the same components of the base station 4, some arrangements 1 may have a remote station 9 that does not include all the components of the base station 4. Moreover, the number and type of remote stations 9 that are included in the various arrangements 1 that employ the vehicle monitoring and reporting system may depend on the desired use.

The data from the vehicle monitoring and reporting system may generally be accessible through an Internet website (shown here as being supported by a third party 10 having an appropriate application server 11) and/or an appropriate Internet/network email system 12. Accordingly, a user (e.g., a customer or employer) may transmit an appropriate signal (via the Internet or network email to the operator of the truck 2 using the vehicle monitoring and reporting system and can provide information (e.g., routing/scheduling changes) to the truck (and thus the operator thereof). The preferred paths of data conveyance are shown with solid arrows 13 that indicate hard line communication paths and dashed arrows 14 that indicate non-hard line (e.g., radio wave or other appropriate signaling mechanisms). However, in other arrangements, data that is shown to be conveyed via hard line communications (indicated by the solid arrows 13) may be conveyed via non-hard line communications (and vice versa). Moreover, additional and/or alternative data paths may also be appropriate between various stations/components associated with the system.

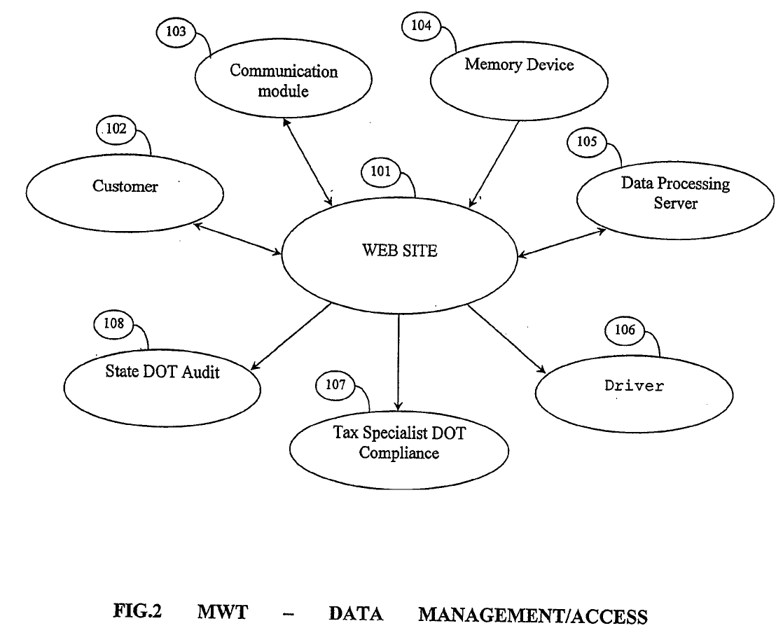

FIG. 2 schematically illustrates how data of the vehicle monitoring and reporting system may be managed and accessed. The data or information to and from a communication module 103 and from a memory device 104 is preferably forwarded to a data processing server 105 through a website 101. A user including at least one of a customer and/or employer 102, DOT (Department of Transportation) authority 108, tax authority 107, and the driver/operator 106 may access relevant data from the website 101 preferably through the use of one or more authentication passwords (access codes). These authentication passwords may indicate a level of data access available to the user. So, for instance, the employer 102 may be able to access more data than the DOT authority 108. Further, these authentication passwords may be encoded into data cards (e.g., operator-/driver-specific data cards 12 that are preferably readable and capable of being written to by the data card reader/writer 8 of FIG. 1).

FIG. 3 diagrammatically illustrates a vehicle monitoring and reporting system 20, and more particularly, a vehicular subsystem 22 thereof that is preferably interconnected with the truck 2. The vehicular subsystem 22 has a GPS receiver 24 which receives signal 26 from a GPS satellite (6 in FIG. 1) via an appropriate antenna 28. This GPS receiver 24 may provide a number of appropriate outputs but preferably provides RS-232 output to a computer (here, one or more micro controllers) 30. The vehicular subsystem 22 also includes a satellite/two-way pager module 32 (with an associated antenna 34) that is used to receive and transmit information/data signal 36. Accordingly, the satellite/pager system 32 may receive information from one or both the base station 4 and the remote station(s) 9 and convey the information to the computer 30 of the vehicular subsystem 22. Likewise, the satellite/pager system 32 may be utilized to transmit vehicle and/or operator information (e.g., data acquired by one or more of the GPS receiver 24, manual input device 42, and odometer sensor/electronic control module (ECM) 54) from the computer 30 to one or more appropriate non-vehicular subsystems 38 (e.g., of the base station 4 and/or the remote station(s) 9). The satellite/pager system 32 and the computer 30 may be communicatively linked in any appropriate manner, but are preferably linked through an RS-232 serial interface. Accordingly, real time data transmission may be accomplished between the truck 2 and one or more of the base station 4 and the remote station(s) 9.

The vehicular subsystem 22 of FIG. 3 also includes an appropriate display 40, a LCD screen for example. This display 40 is provided to at least generally display information relating to the vehicle monitoring and reporting system 20, such as status information including, but not limited to, latitude, longitude, date, time, and miles information of the truck 2. A manual input device 42 is also included in this vehicular subsystem 22. This manual input device 42 may include one or more of a keypad/keyboard, a mouse, a paddle, and a joystick. Here, the manual input device is a keypad that, for example, may have a 4×4 matrix. This manual input device 42 is communicatively connected to the computer 30 and may be used by the vehicle operator for data entry. A data card reader/writer 44 is communicatively interconnected with the computer 30 (preferably through a high-speed serial interface or the like). Moreover, this data card reader/writer 44 preferably includes a dedicated RISC micro controller or other appropriate controller to enable read/write operations.

Still referring to FIG. 3, at the end of each vehicle trip, trip information can be downloaded from the computer 30 into a driver-specific data card 12 (FIG. 1) via the data card reader/writer 44. Along with the data exchange that is provided by the satellite/pager system 32, this reading/writing data to the data card 12 provides another mode of data retrieval. While not real time, this data card-based protocol associated with the vehicle monitoring and reporting system 20 is useful on a variety of levels including end of trip reporting. Further, data card 12 data transfer is also beneficial in when trucking routes go through areas that are not appropriately covered by the satellite/pager system 32. Online e-mail/satellite 3b transmission (FIG. 1) may not be provided in all stations (e.g., 9); however, it is preferred that the base station 4 be equipped with online e-mail/satellite 3b transmission/receiving capabilities. In the case of a trucking company application, company offices are preferably equipped with a data card reader/writer 44 and software for generating appropriate reports from the raw data extracted from the data card 12. Moreover, these company offices also are preferably equipped with software for generating appropriate reports from the data received through appropriate Internet conveyances.

With regard to other components of the vehicular subsystem 22 of the vehicle monitoring and reporting system 20, the computer 30 may include provision for a RS232 serial port 46 (e.g., for communicating with one or more CPU's 6 (FIG. 1). Moreover, the vehicular subsystem 22 may include appropriate provisions for one or more of a database 48, software 50, a backup memory 52, odometer signaling 54, a low battery indication 56, and a power supply 58.

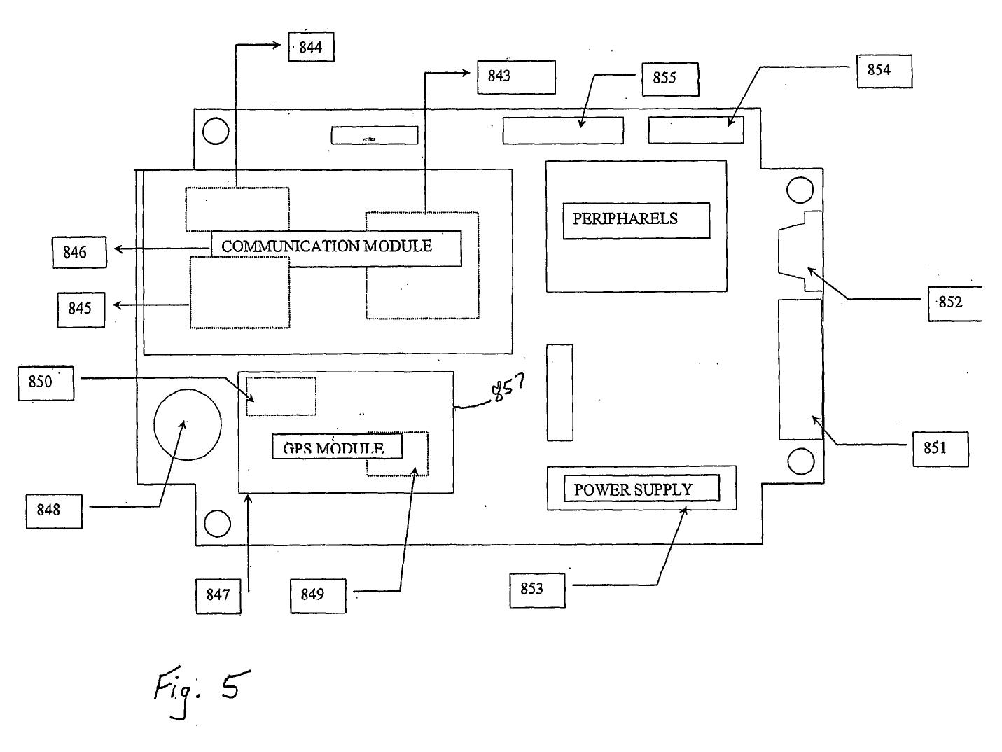

FIGS. 4A-F illustrate system hardware components and an appropriate connection schematic thereof. More particularly these hardware components include a micro controller board, an LCD board and a keypad. The micro controller board consists of two micro controllers, in which one acts as a “master” and another one as a “slave.” The master (e.g., a MOTOROLA MMC2107) preferably controls a significant amount (and sometimes, virtually all) of system function. The slave is used for what may be referred to in the art as a “smart card” function. Here, a Max 232 RS232 transceiver IC is used to interface with the CPU 6 of the base station 4. While any of a number of appropriate serial flash is used for data storage. An RS232 to RS485 converter (or other appropriate converter) s also employed to get mileage input from the ECM of the engine. More particularly, this is accomplished, at least in part, by use of a dual channel multiplexer and de-multiplexer for selecting the communication mode either RS232 or RS485. An optocoupler or the like is used to sense the odometer pulse input.

FIG. 5 illustrates a printed circuit board layout and component location. The main power to the micro controller board is connected through an appropriate power connector 851. The input power is converted to low voltage by the power supply regulator 853 and connected to integrated chips. The motherboard has two micro controllers, whereby one at least generally acts as a CPU 843 and the other at least generally acts as a data card controller 849. The CPU 843 may be any appropriate controller such as a Motorola Mcore MMC 2107 32-bit controller. The data card controller 849 may be any appropriate controller such as an Atmel AVR RISC controller. The CPU 843 controls a significant portion (and potentially all) of the functions and may be said to at least generally control the slave devices, which may include, but are not limited to, the data card controller 849, a GPS receiver 857, and a satellite/pager module 846. A plurality of external memories 844, 845, 850 are included to be used for data storage. An onboard battery 848 is used to provide power backup for events when power supplied through the power connector 851 is disconnected or otherwise unavailable. External devices, and more particularly, an external PC/ECM 852, a keypad 854, and one or more programming inputs 855 are connected at the indicated terminals.

The micro controller 843 at least generally processes information received from the GPS receiver 857, the keypad 854, and the input terminal (e.g., interconnected with the odometer sensor/electronic control module (ECM)) and transmits the information periodically or upon request, and also stores the data in the onboard memory 850. At the end of the trip, at least some (and preferably all) of the trip data is stored in the data card 12.

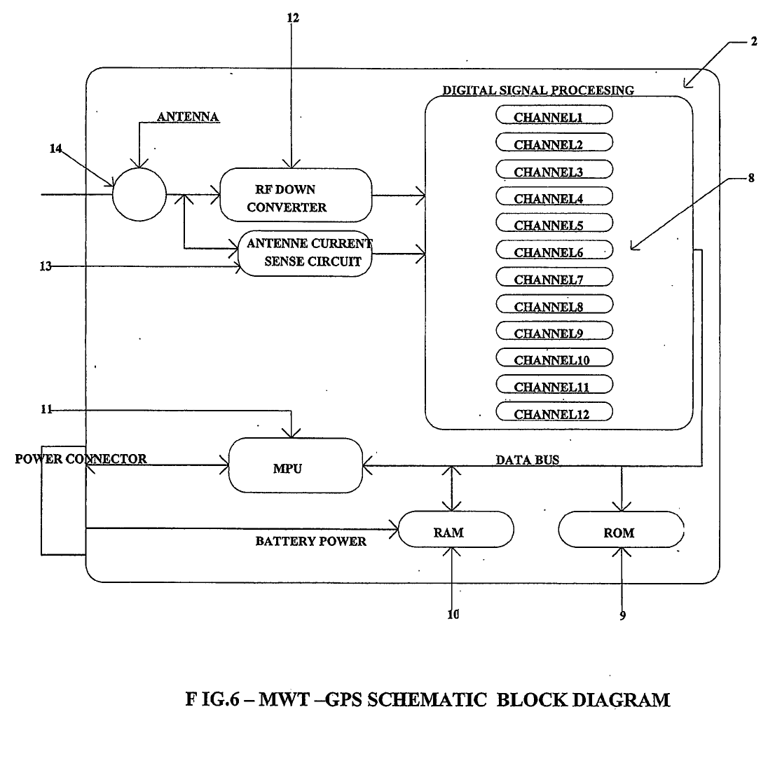

FIG. 6 illustrates the external diagram of Motorola M12 global positioning system or equivalent which has 12 channel tracking capability as indicated. The GPS module ideally continuously tracks GPS satellites and calculates time/position information. The calculated information is transferred to the micro controller board through serial interface connector 12. An appropriate type of power (e.g., 3V DC power) is supplied to the GPS module through the same connector. In the illustrated embodiment, the GPS module serial connection works at 9600 bps, no parity 8 data bits, 1 stop bit connection with an m12 binary protocol.

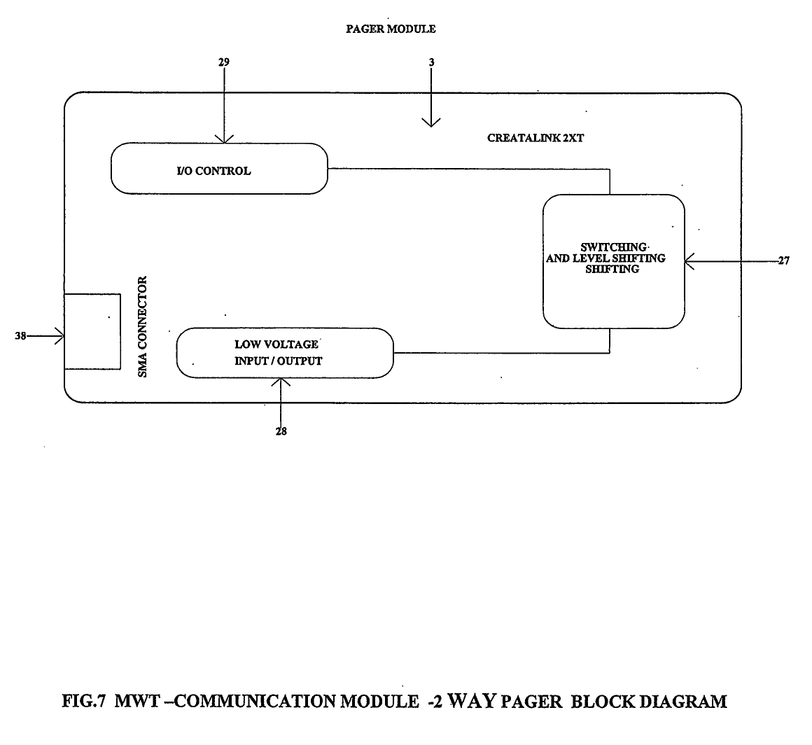

FIG. 7 shows the block schematic of pager module, which has a serial interface through which the pager is connected to the micro controller board.

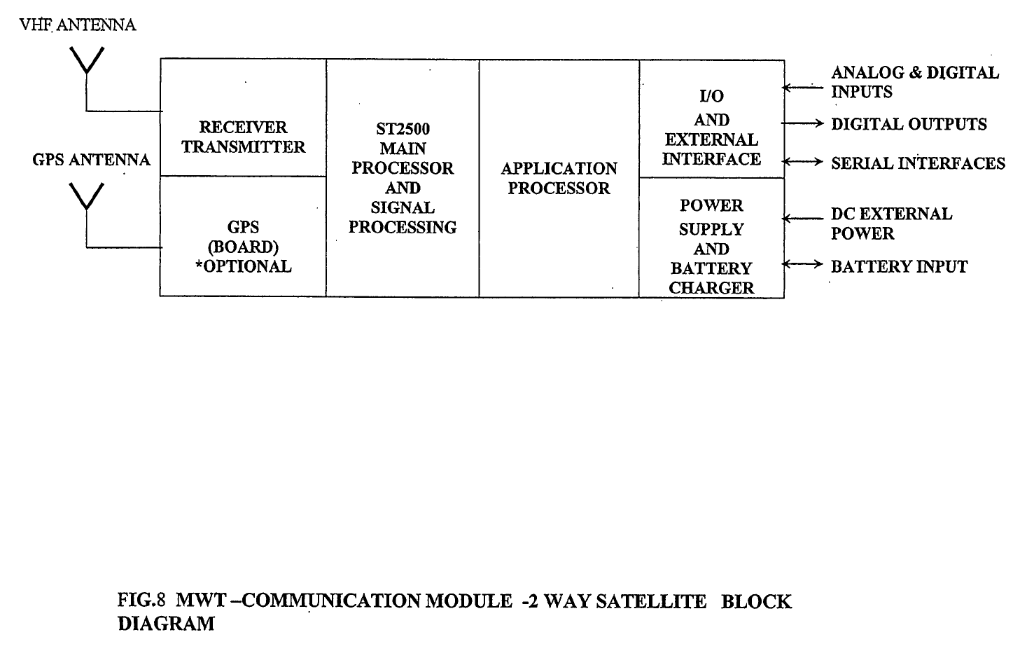

FIG. 8 is a block diagram of the two-way satellite communication module. It consists of a main processor for communication purpose and an additional separate controller for supplemental applications, transmit, receive circuits and battery charging circuit.

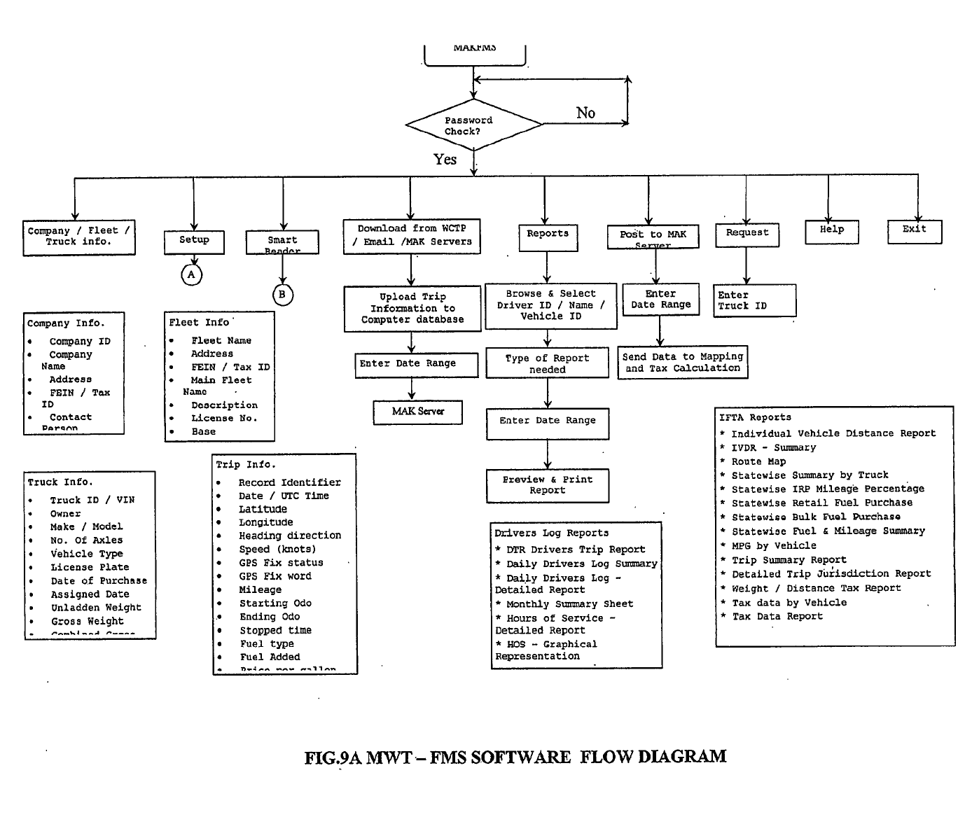

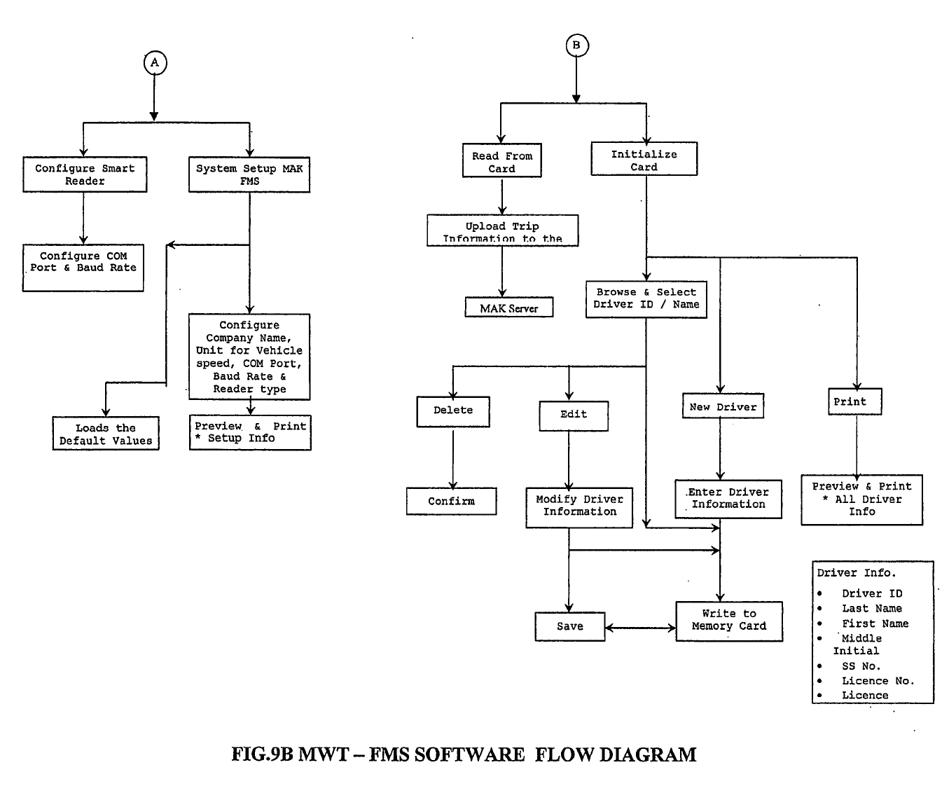

FIGS. 9A and 9B illustrate a software flow diagram for a vehicle monitoring and reporting system (e.g., 20) adapted for trucking company management. This embodiment is a customized web enabled software which may be hosted in a website. The user can login using a password and create one or more of the various reports above. Also, the user can locate any particular truck at a particular time. The flow of operation and data collected and processed are shown in the schematic.

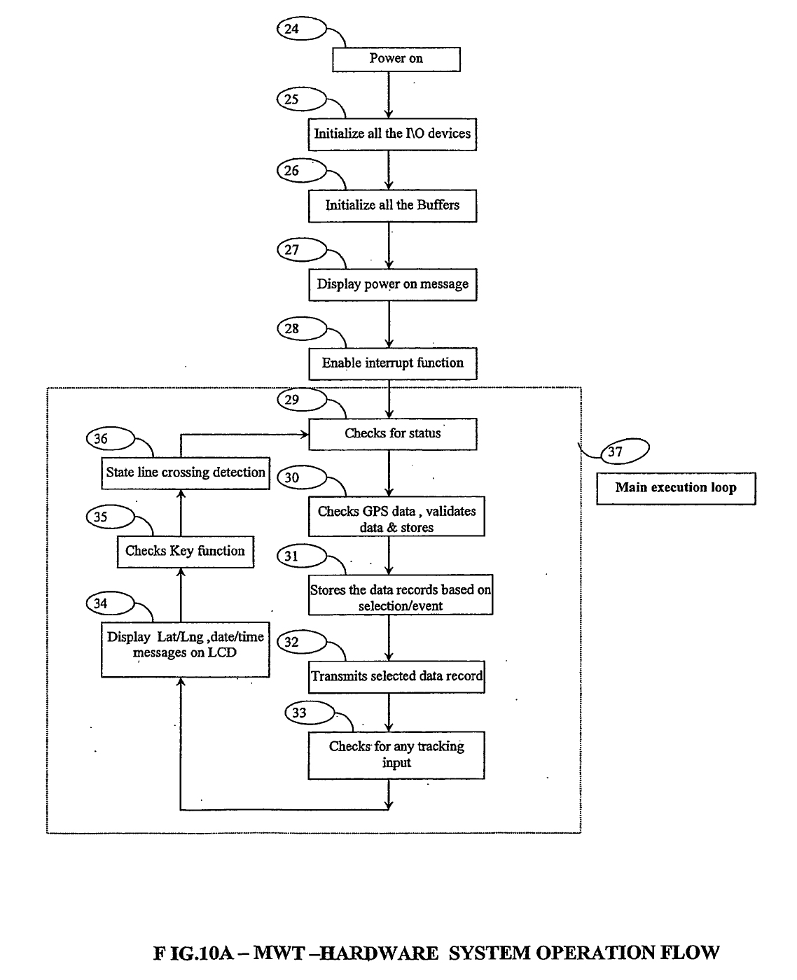

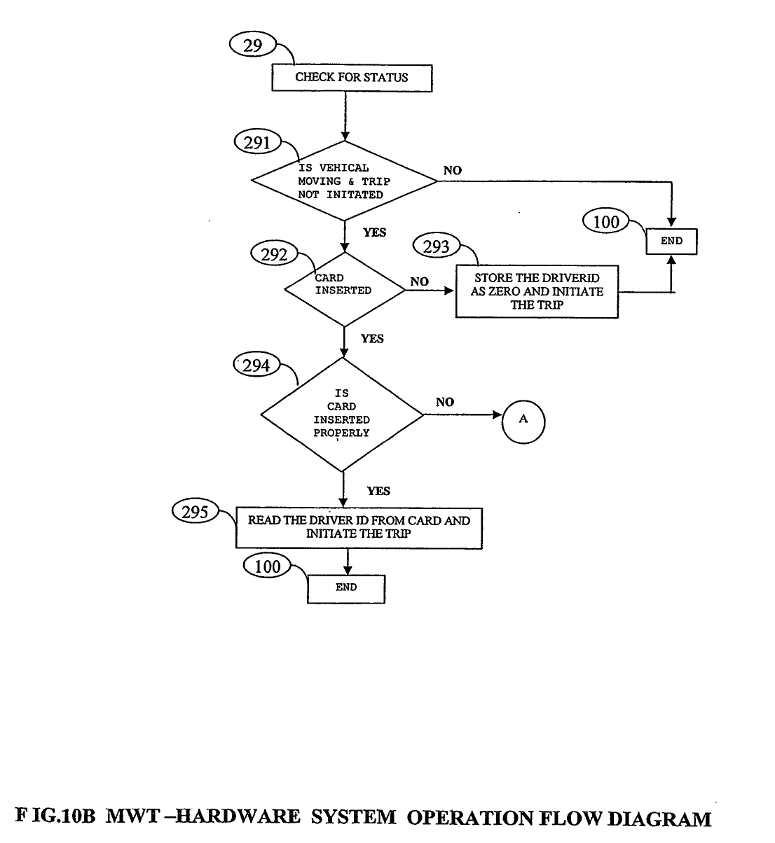

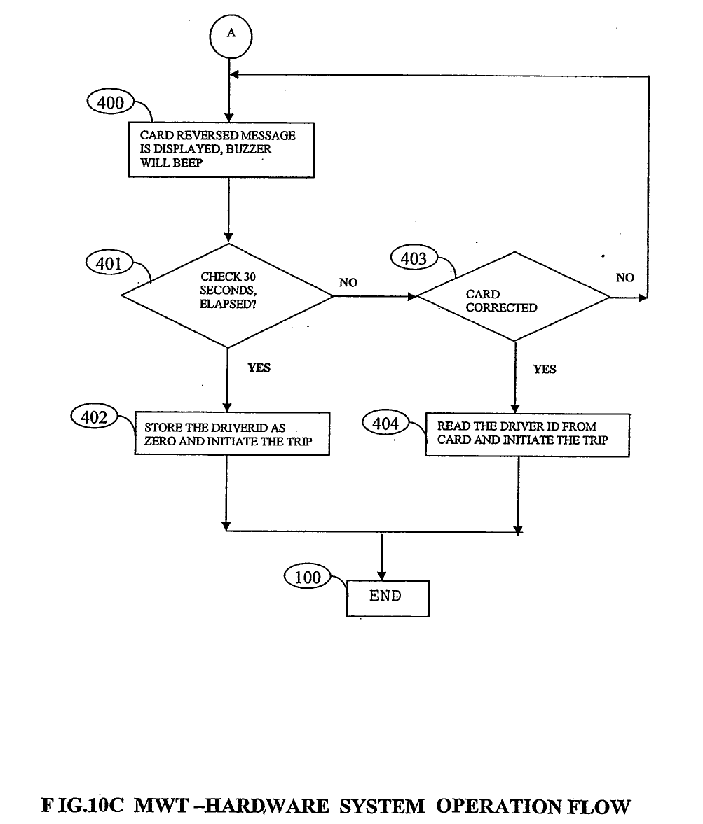

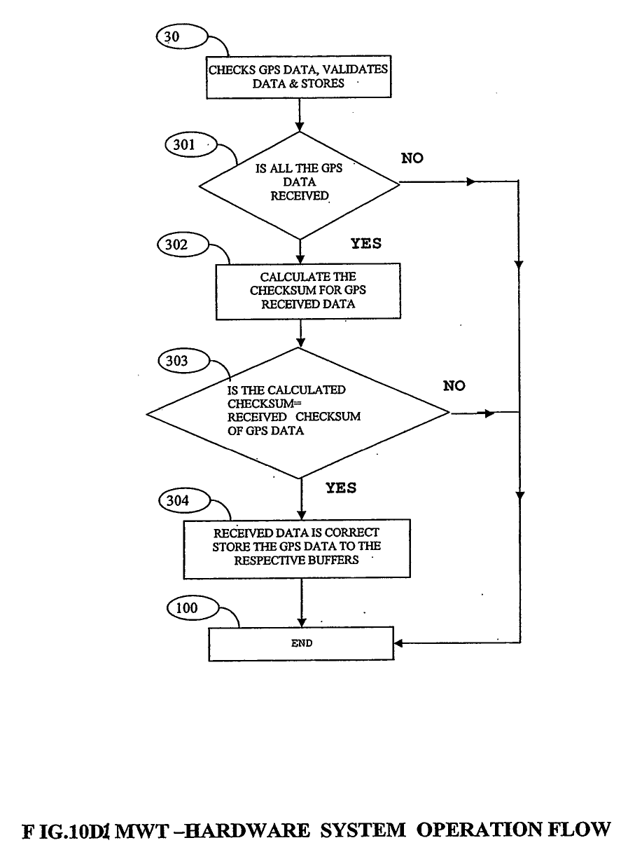

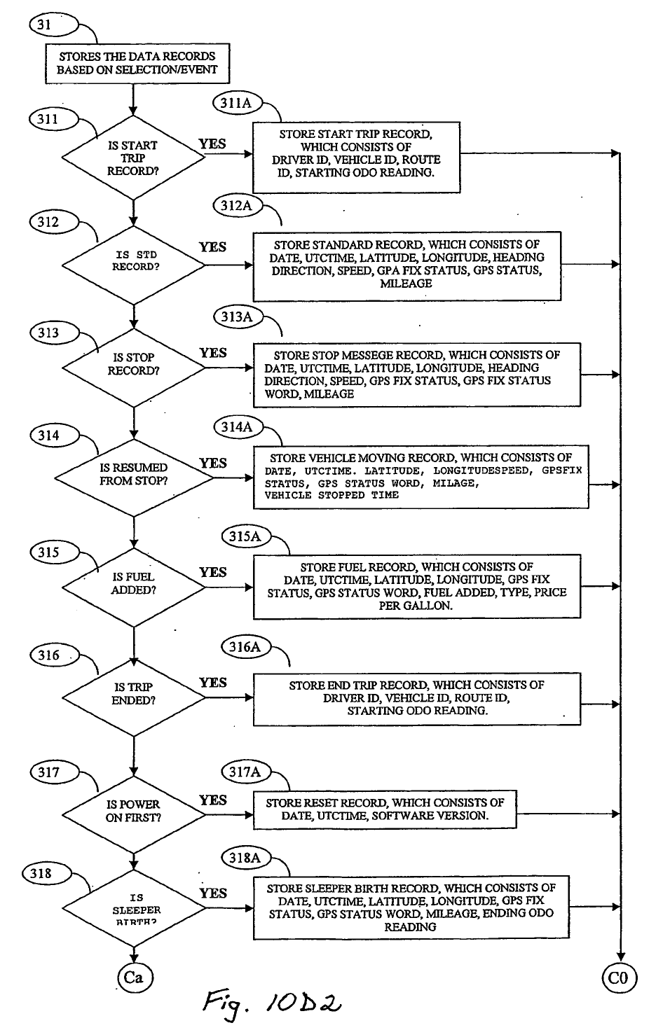

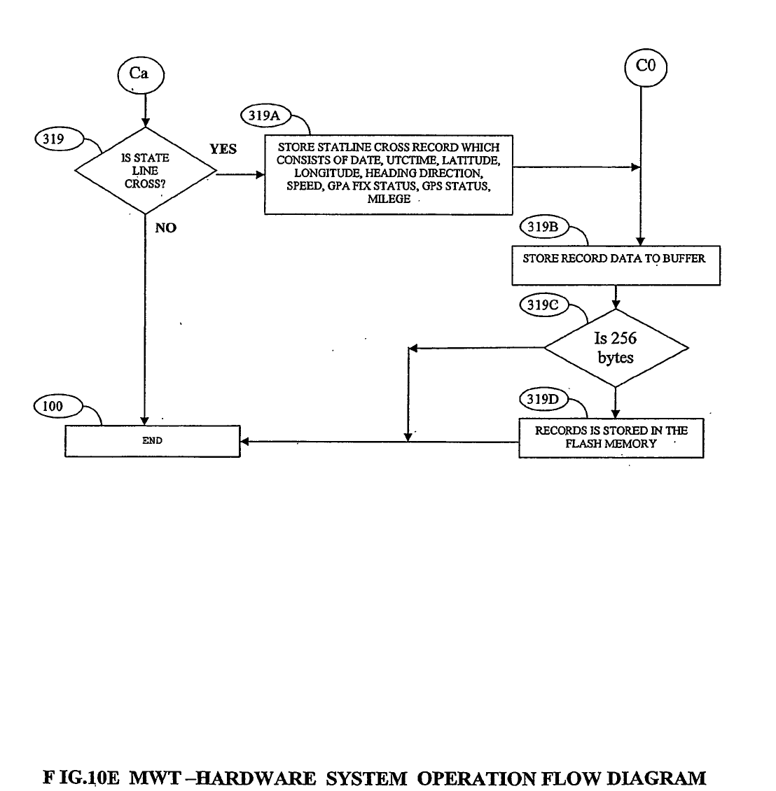

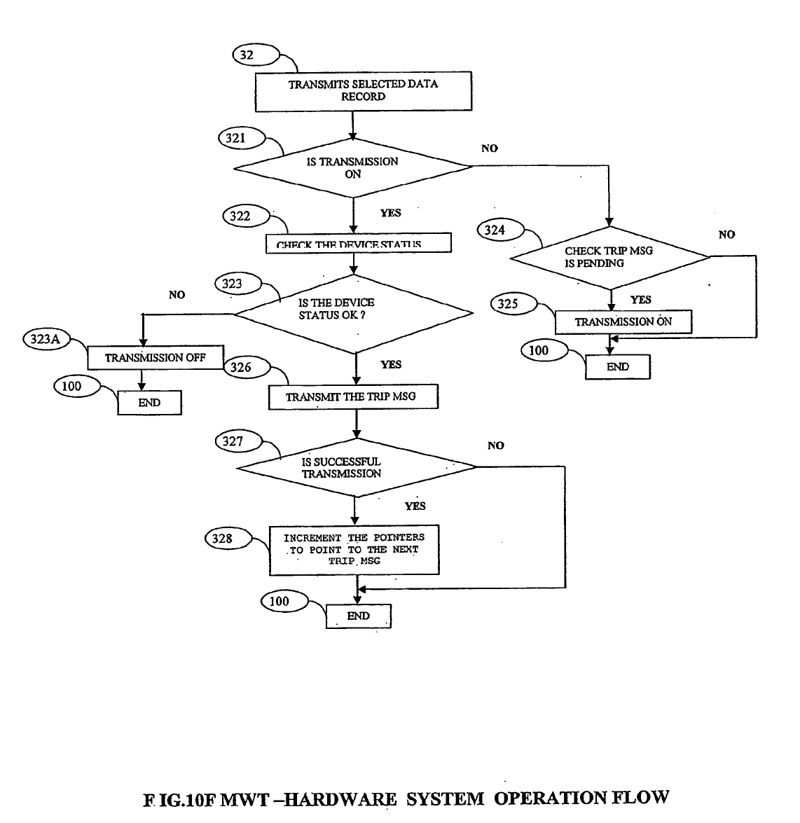

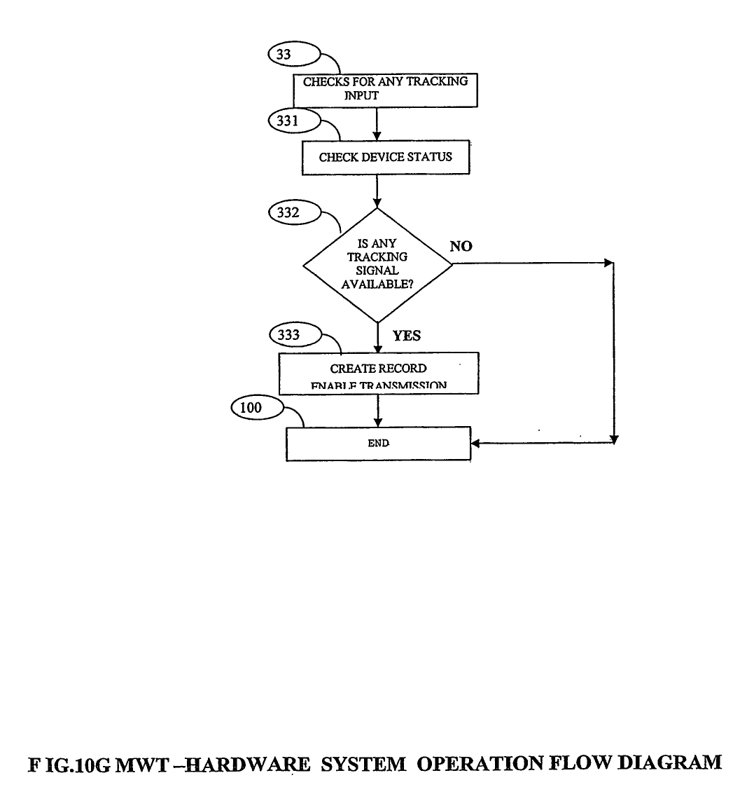

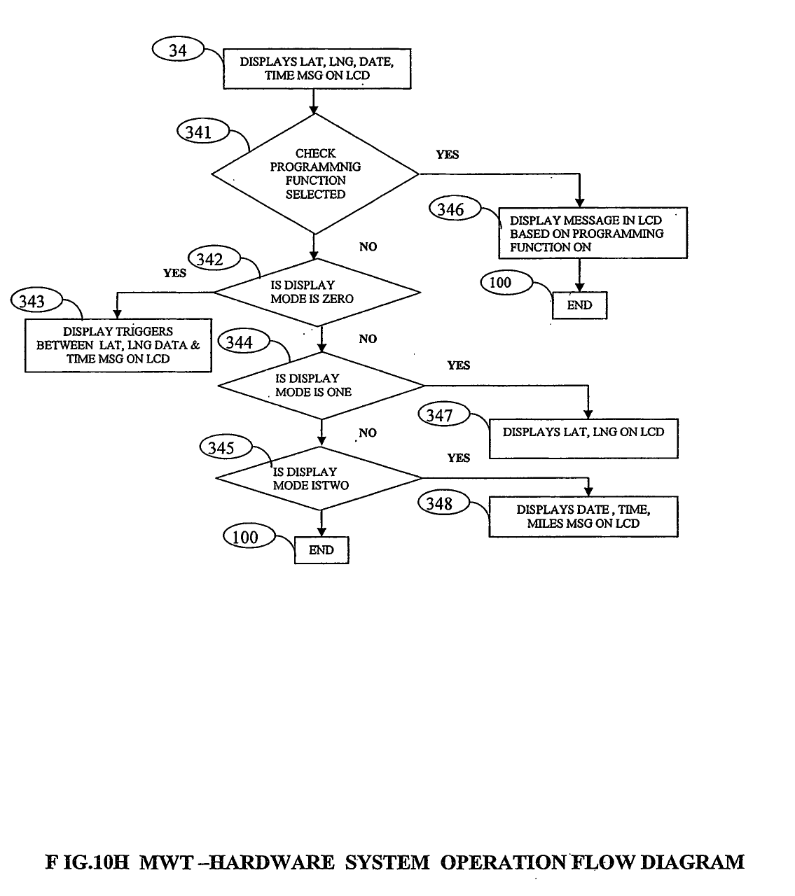

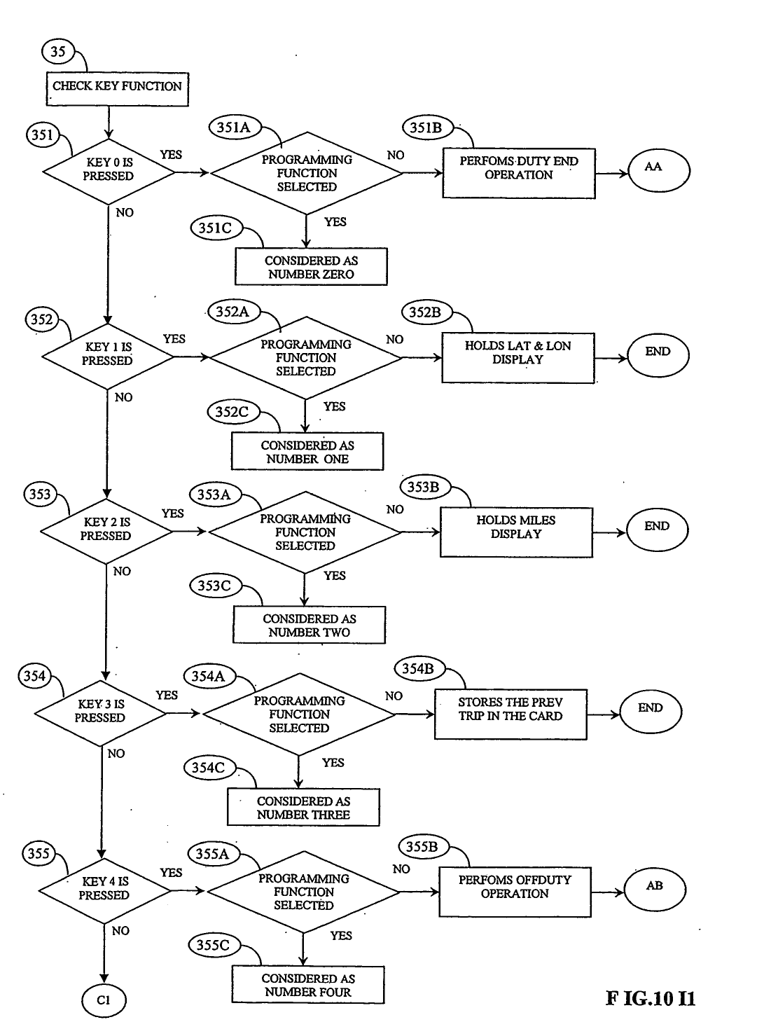

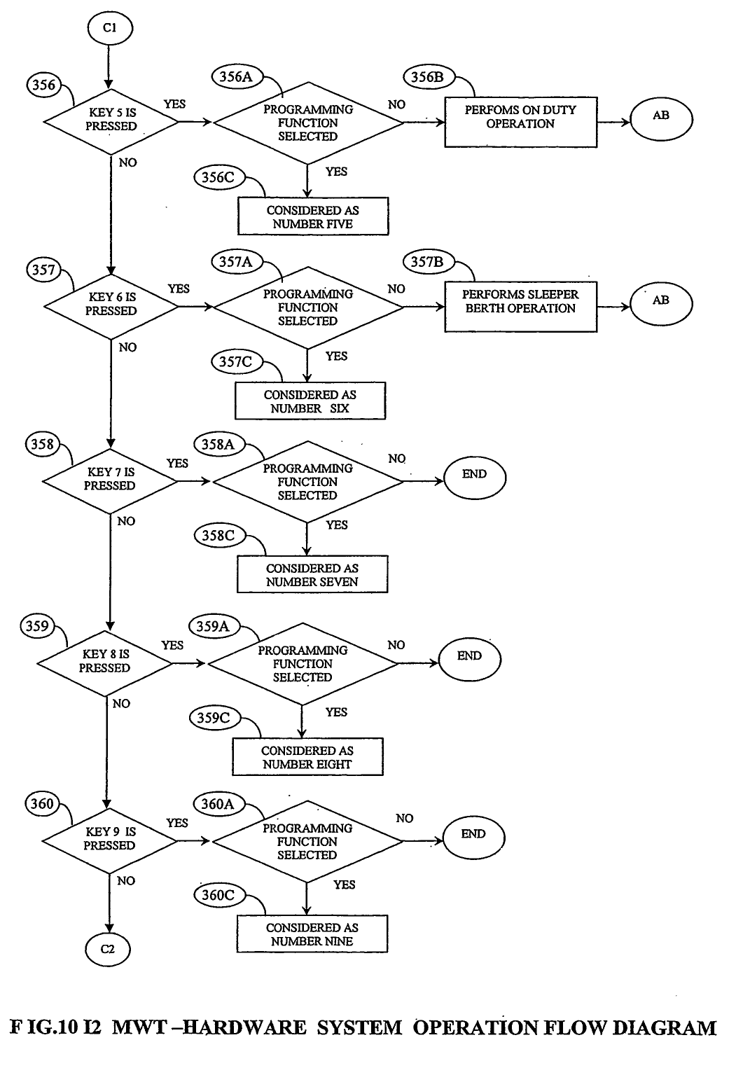

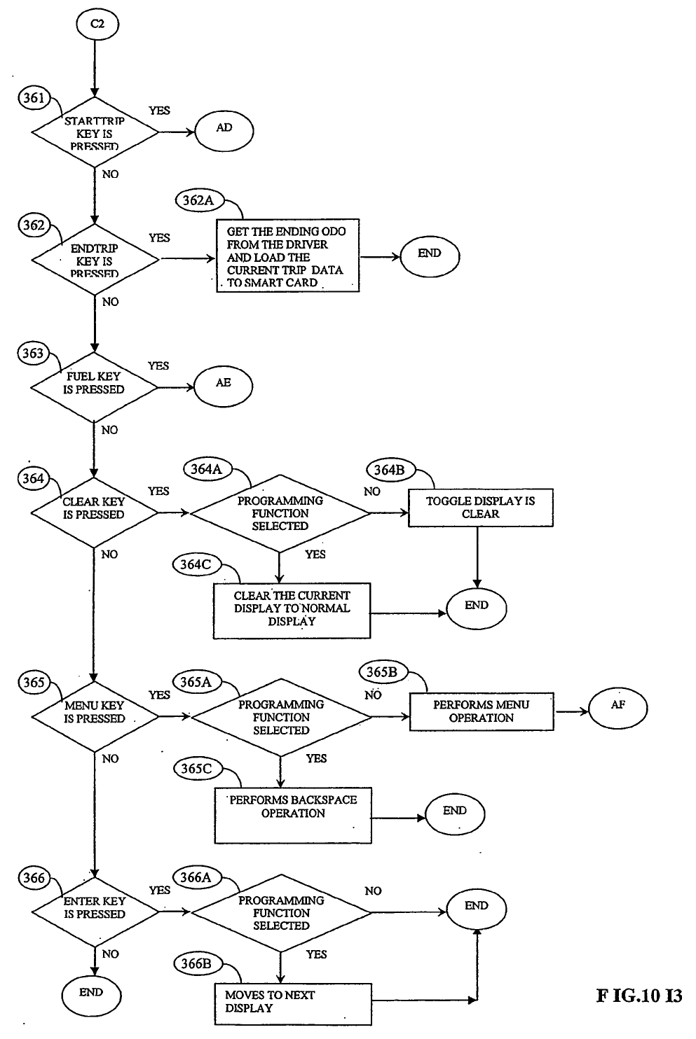

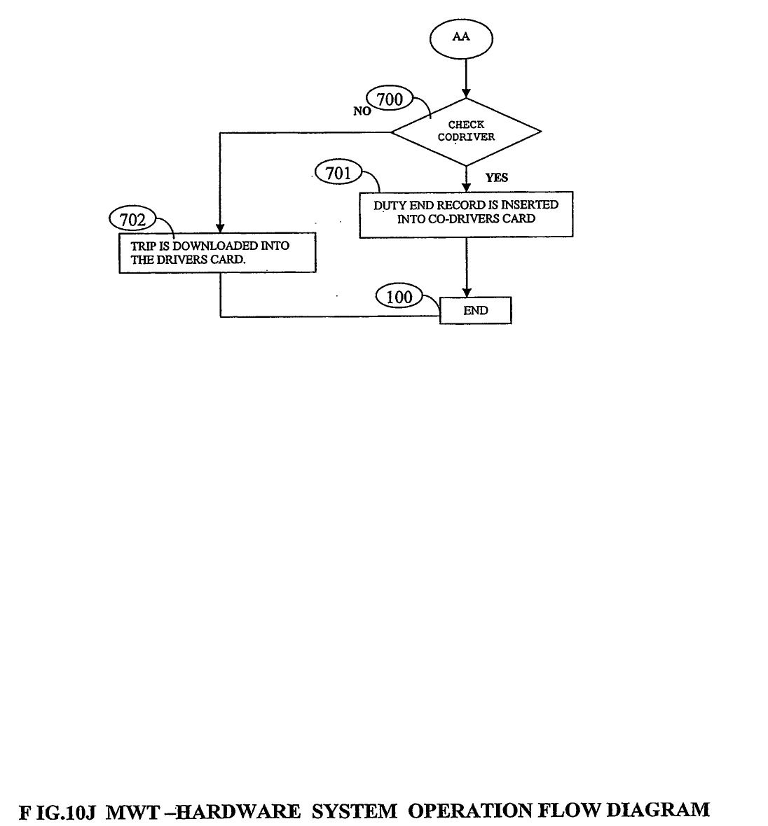

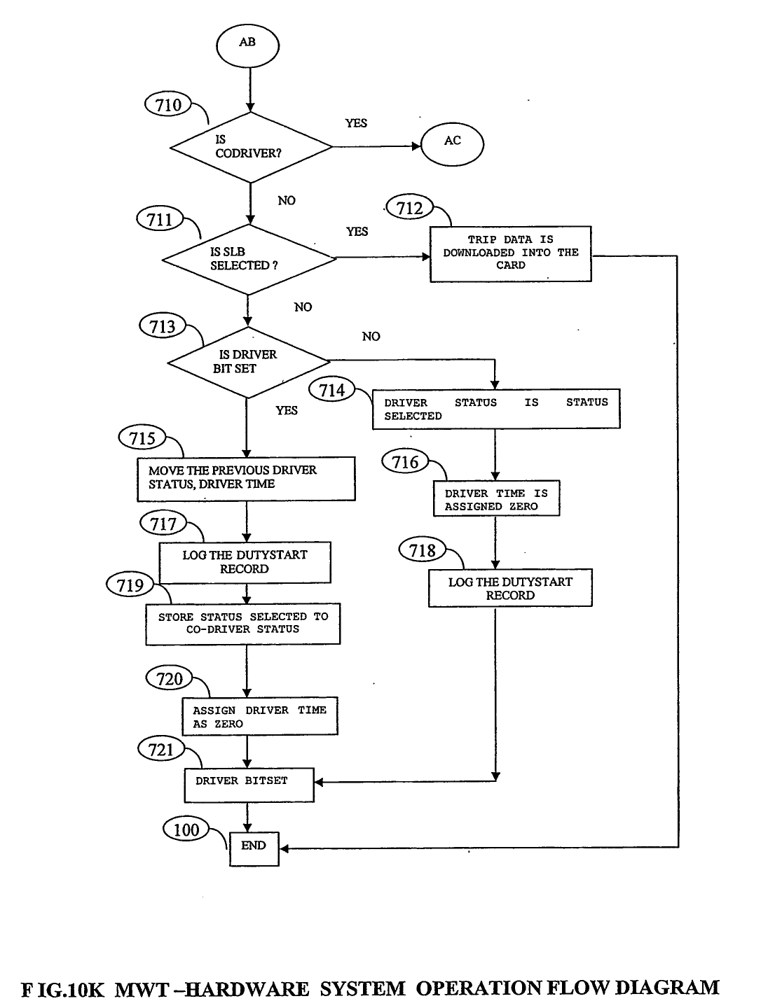

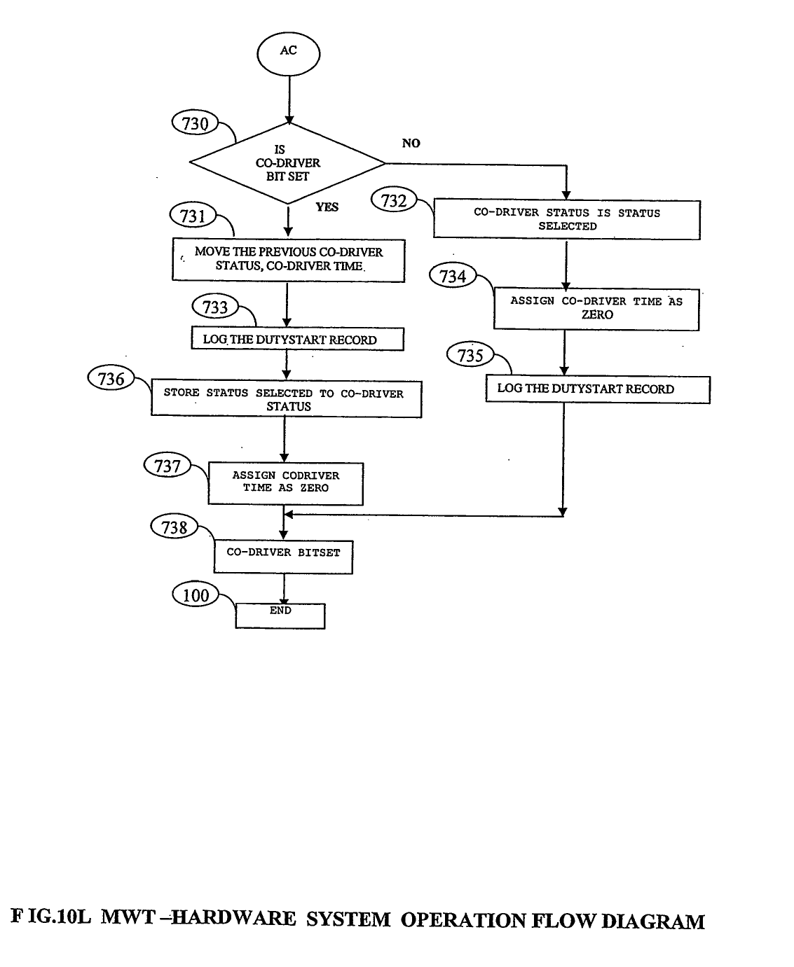

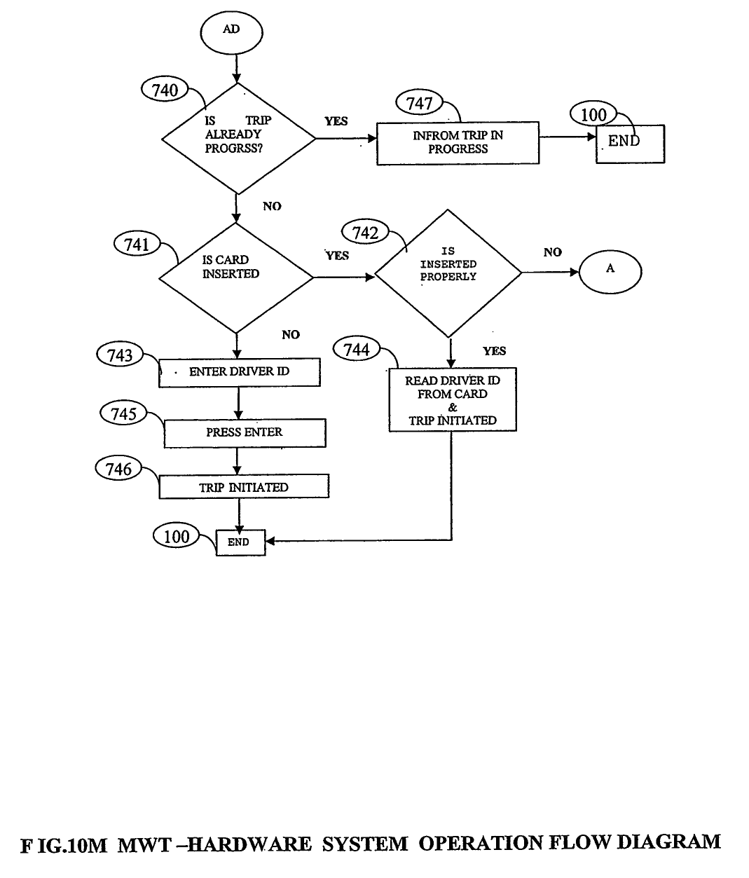

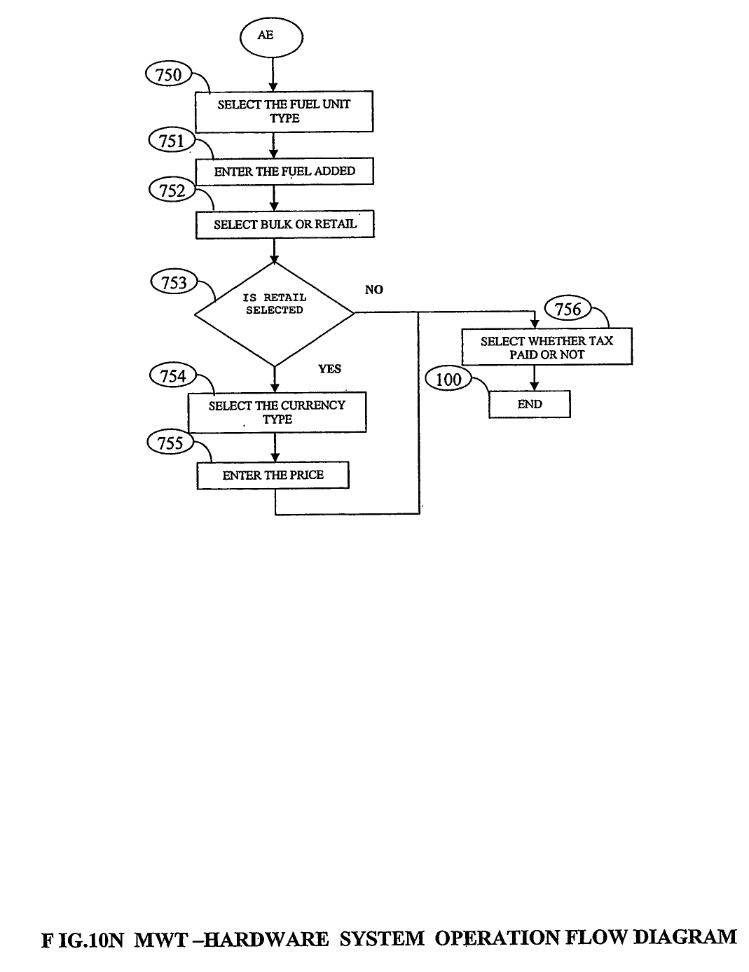

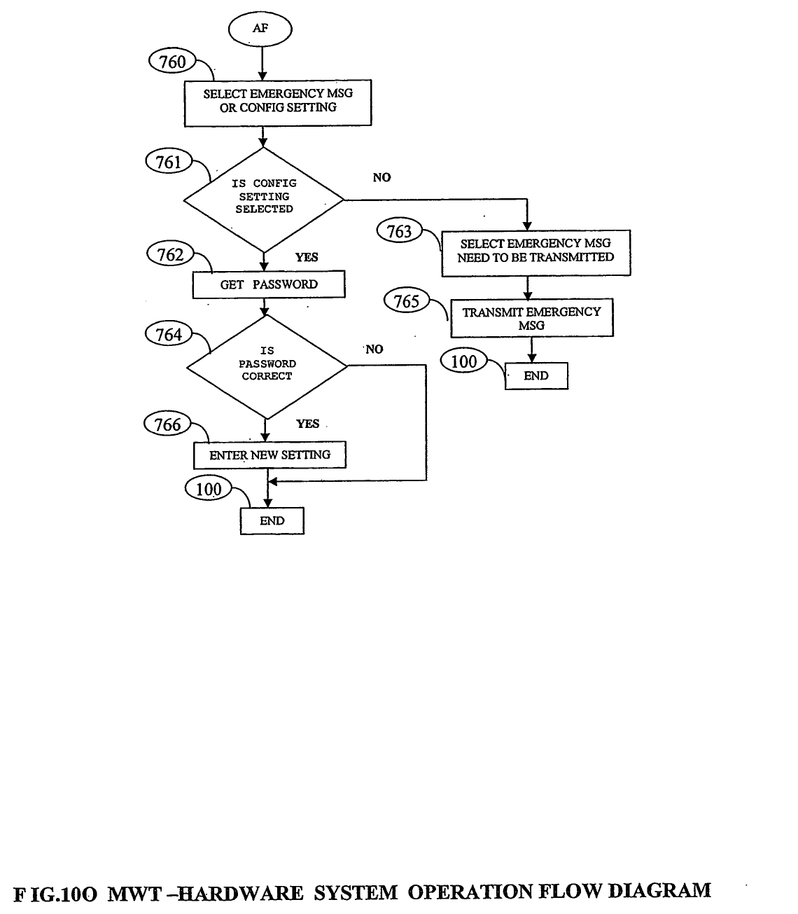

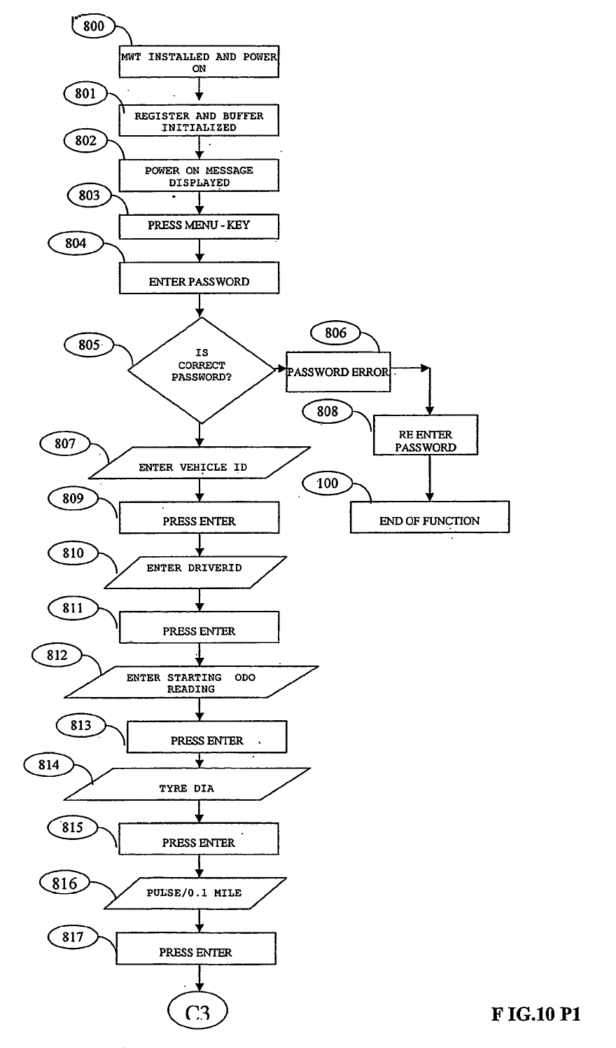

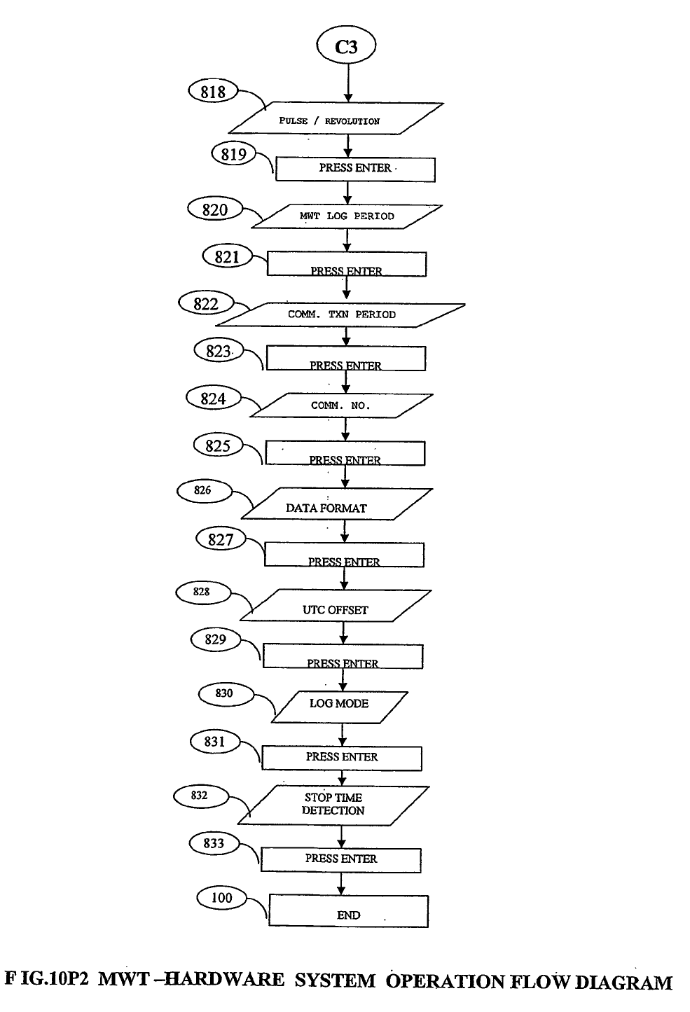

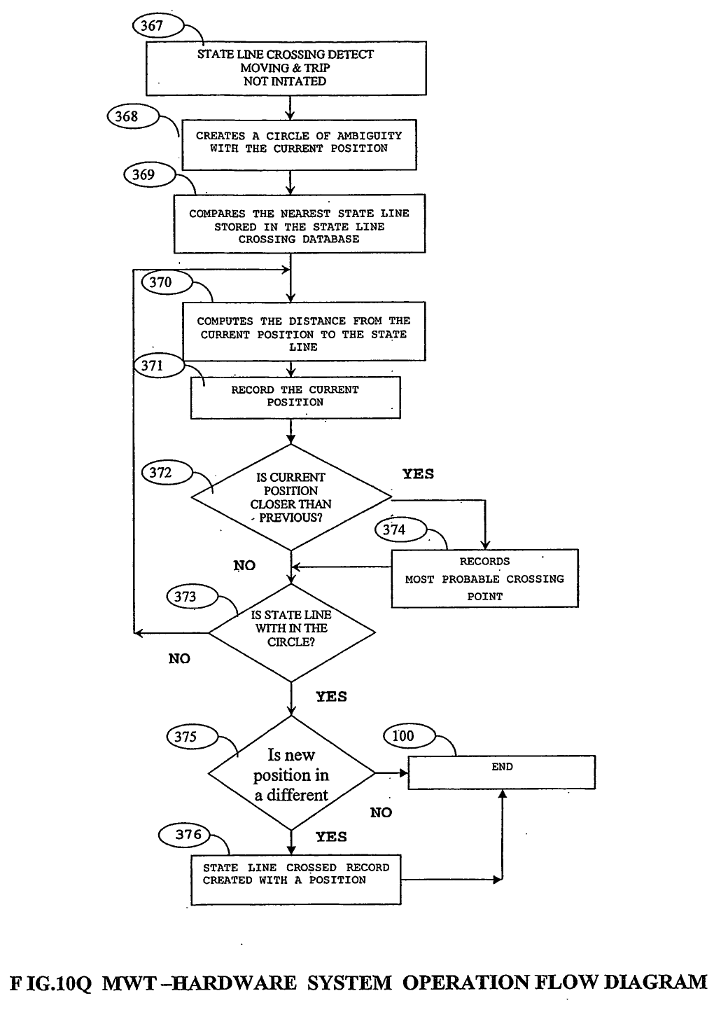

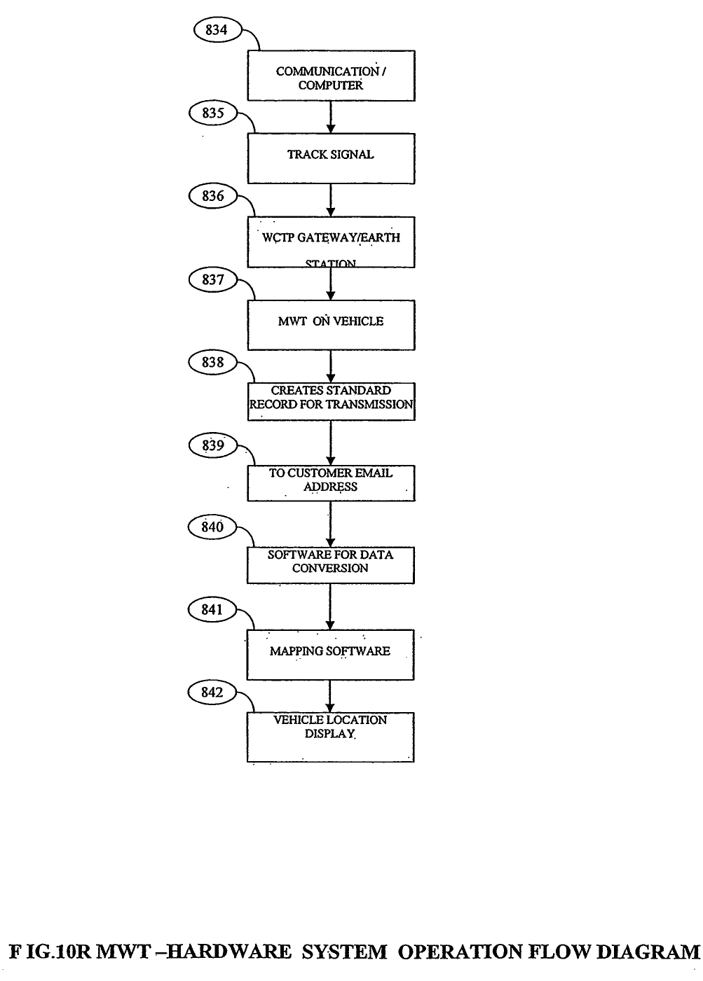

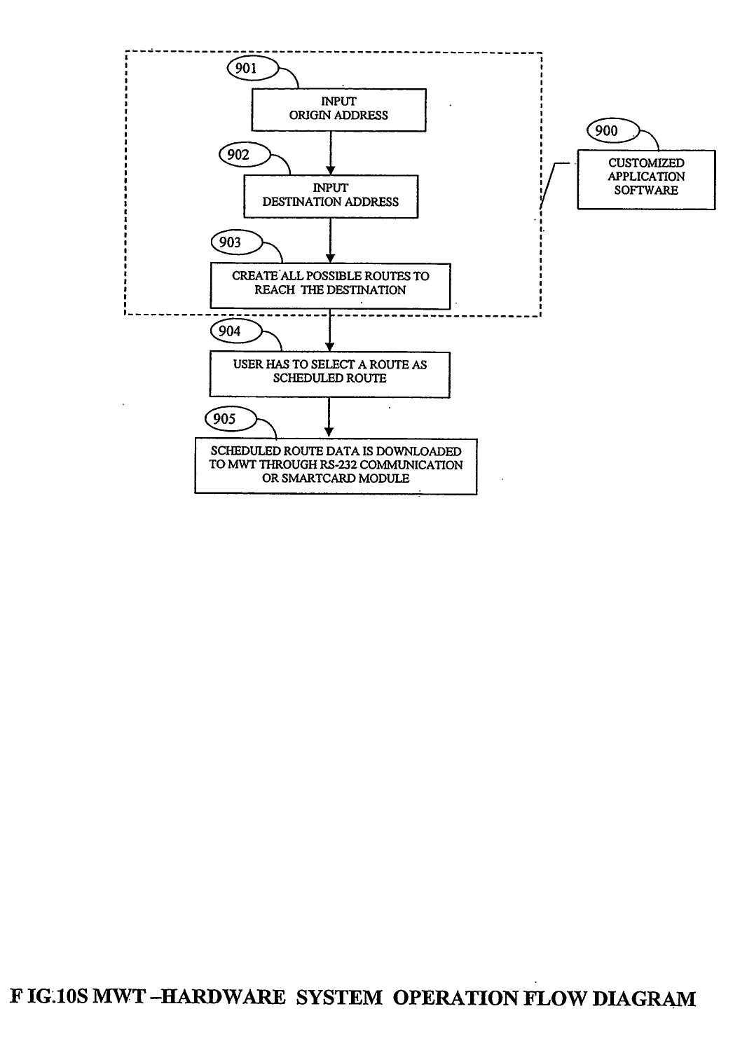

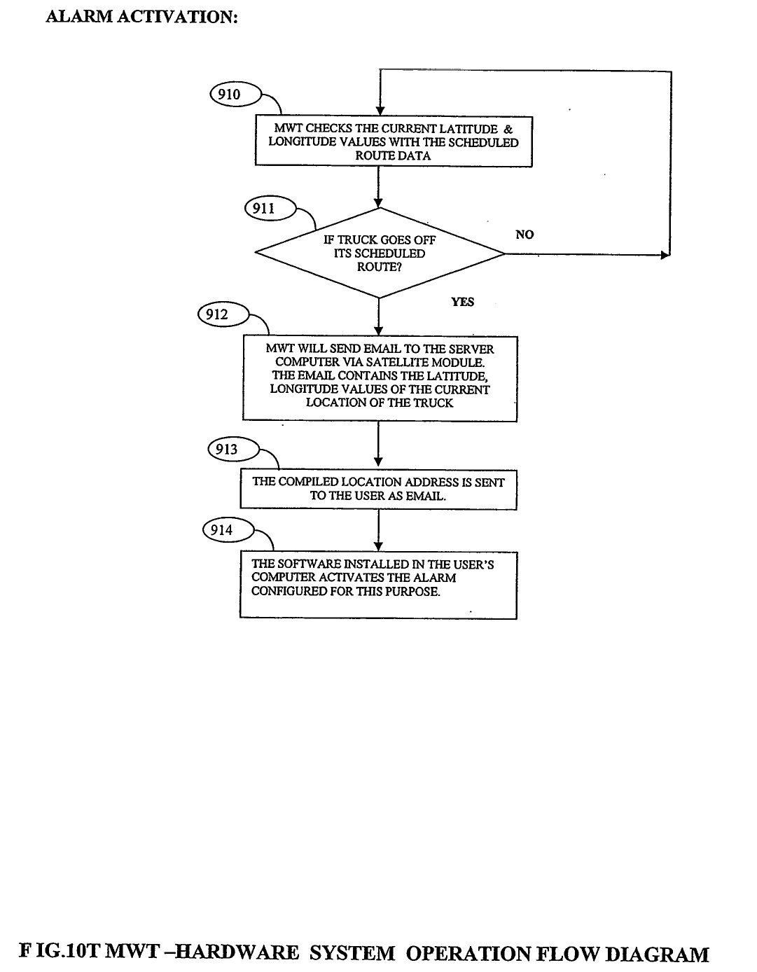

FIGS. 10A-T illustrate operational flow relating to the vehicle monitoring and reporting system 20. Once the device is powered on 24 it initializes the registers 25 to its default/initial value and initialize the buffers 26 used in the program to their default/initial value. The system may then display a power-on message 27 and provides a system status check of sorts. An “enable interrupt” function 28 is used to at least generally activate a background running function to receive one or more of GPS data and pager/satellite data (including, but not limited to, miles calculation using odometer pulse and timing calculation for periodic intervals).

The “in-checks-for” status 29 checks for vehicle movement without trip initiation 291. If the trip is not initiated 29 status, the system checks for data card insertion 292. If the memory device is inserted properly 294, then driver identification is preferably read from the data card 295 and a trip is initiated. If the data card (which may also be referred to herein as a “memory device”) is not inserted, the system will inform the driver about unknown driver ID 293 and the trip may be initiated. The start trip record data and standard record data is stored in the flash memory as well as being transmitted through communication device. Moreover, one or more appropriate buffers may be loaded with the programmed values for updating. If the memory device is not inserted properly, then the operator is informed about the card's improper insertion 400 and waits for 30 seconds 401. Before time elapses, if card insertion is corrected 403, the driver identification is read from the data card, and the trip is initiated 404. If time elapses, the device provides notification of the unknown driver identification and the trip may be initiated 402.

Based on selection or event, records may be created and stored by the system 31. Moreover, the system checks whether a start trip record has been selected 311. If the start trip record is selected, the system stores the start trip record data in the temporary memory 311A. In a subsequent step, the system may be utilized to determine whether or not a standard record is selected 312. If a standard record is selected, the system stores the standard record data in the temporary memory 312A. The system may also determine whether or not a stop record is selected 313. If the stop record is selected, the system preferably stores the stop record in the temporary memory 313A. Further, the system is capable of checking whether or not a resume record is selected 314. If resume record is selected, it stores the resume record (indicative of the vehicle moving once again) in the temporary memory 314A. If a fuel record is selected 315, the system preferably stores the fuel record in the temporary memory 315A. If an end trip record is selected 316, the system stores the end trip record in the temporary memory 316A. The system may also be utilized to check whether or not power is being supplied 317. If the unit is powered, the system stores the reset record in temporary memory 317A. If a sleeper berth record is selected 318, the system stores the sleeper berth record in the temporary memory 318A. If a state line record is selected 319, it stores the state line record in the temporary memory 319A. The system preferably also is capable of determining if a maximum of data storage (e.g., 256 bytes) is reached in temporary memory 319C. If 256 bytes of data are reached in temporary memory, additional records may be stored in the flash memory 319D.

Referring to FIG. 10A, The data received from the GPS receiver may be checked for errors, validated and stored 30 in an appropriate memory location. This function starts with checking if all the GPS data is received 301. If all the GPS data is received, a checksum for the received GPS data 302 may be calculated, and whether the calculated checksum is equal to the received checksum of GPS data is determined 303. If the calculated checksum is equal to the received checksum of GPS data stored, the GPS data is sent to appropriate buffers 304 for storage.

Referring to FIG. 10F, the selected data record may be transmitted 32 through an appropriate pager/satellite communication device. Once data is ready for transmission, data pending will set. In this, a determination is made as to whether the data transmission is in “ON” condition 321. If the transmission is in ON condition, it checks the communication device status 322. If status of the device is correct 323, then it transmits data 326. If device status is not correct, clear transmission is switched on and sequenced to try later. If transmission success 327, update pointers 328 are directed to fetch the next data. If the transmission fails, data pending will remain unclear. If the transmission is in OFF condition, it will check for any message pending 324. If yes, the system sets to transmission ON 325 and returns.

Referring to FIG. 10G, a tracking input signal is checked 33 for any request availability. A first function is to check the device status 331. If status is satisfactory, then it checks for any request signal 332. If yes, the communication device will prepare to transmit data 333 to the requested email address. If no signal is received, the system simply returns from the function 100.

FIG. 10H shows that the data display (including latitude/longitude, date/time message on LCD 34) may be selected (e.g., by manipulating the appropriate keys of the keypad). When there is no programming mode selected 341, and the mode zero is selected 342, the hold latitude/longitude data is displayed on the LCD 343. If mode one is selected 344, the LCD display 347 is toggled. If mode two is selected 345, the LCD holds date, time, miles display 348. It toggles the LCD display 343. If mode one is selected344, the hold latitude/longitude data is displayed on the LCD347. If mode two is selected 345, the LCD holds date, time, miles display data 348. If it is in programming mode, the system will hold the previous selection 346.

Referring to FIG. 10I1, in “key check” function 35, if an appropriate key (e.g., key “0”) is pressed 351, the system checks whether the programming function is selected 351A. If programming function is not selected, the system performs an appropriate “duty end” operation 351B and co-driver 700 (FIG. 10J) duty end data will be stored in the data card 701. If not, the data will be downloaded to main driver data card 702 as shown in FIG. 10J. Referring back to FIG. 10I1, if programming function 351A is selected, the system may coincide that with a number zero entry 351C. If key “1” is pressed 352, the system checks whether programming function is selected 352A. If the programming function is not selected it holds the latitude and longitude display 352B. If the programming function is selected, the system will consider it as number one entry 352C and will check whether key “2” is pressed 353. The system then checks whether programming function is selected 353A and if the programming function is not selected, it will hold time and miles display 353B. If programming function is selected, it will be considered as number two entry 353C and will check whether key “3” is pressed 354. Again, the system will check whether programming function is selected 354A and, if yes, is taken as a number three entry 354C. Otherwise, the system will download previous trip data 354B. The system also checks whether key “4” is pressed 355 and checks whether programming function is selected 355A. If the programming function is not selected, the system may perform an off duty operation 355B as indicated in FIG. 10K. If co-driver 710 is already set 730, the previous driver status is moved (or changed) 731, logged 733, stored 736, re-initialized (time is set to zero) 737 and bitset 738. If bit 730 is not set, co-driver status is selected 732, co-driver time is reinitialized 734, and log records are sequenced 735. If a co-driver is not selected, the system checks for sleeper berth 711, and, if affirmative, the system downloads data to the data card 712. If not, the co-driver is already set 713, moved 715, logged 717, stored 719, re-initialized 720, and set 721. If no driver bit is set, driver status is selected 714 and time is reinitialized 716, logged, and records are sequenced 718. Referring to FIG. 10I1, if the programming function is selected, it will be considered as a number four entry 355C. It then checks whether key “5” is pressed 356 (FIG. 10I2) and checks whether programming function is selected 356A. If the programming function is not selected, the system performs on duty operation 356B. If the programming function is selected, it will be considered as a number five entry 356C and will check whether key “6” is pressed 357. The system then checks whether programming function is selected 357A and if the programming function is not selected; it performs sleeper berth operation 357B. If the programming function is selected, it will be considered as number six entry 357C, and the system will check whether key “7” is pressed 358 and then check whether programming function is selected 358A. If the programming function is not selected, the system will simply return. If programming function is selected, it will be considered as number seven entry 358C and check whether key “8” is pressed 359. The system then checks whether programming function is selected 359A and if the programming function is not selected, it simply returns or ends. If programming function is selected, it will be considered as a number eight entry 359C, and it will check whether key “9” is pressed 360. The system then checks whether programming function is selected 360A. If the programming function is not selected, again, it simply returns. If programming function is selected, it will be considered as number nine entry 360C, and the system checks (FIG. 10I3) whether the “clear” key 364 is pressed after checking start trip 361, end trip 362 and fuel key 363. The system then checks whether the programming function is selected 364A, and if the programming function is not selected, it enters display toggle mode 364B. If programming function is selected, the selection will be used to clear the current display 364C.

If a “menu” key is pressed 365 and program mode is not selected 365A, the system goes to select menu functions 365B and the operations detailed in FIG. 100. It then checks whether the configuration parameter is selected 761. If yes, it sequences to retrieve and/or check a password 762. If the password received is correct 764, the input new settings 766 are entered. If the password is not correct, the system displays “password error” or the like and simply displays the data without it being editable. If an emergency message function is selected 763, it transmits a selected message 765. If in program mode (also referred to herein as “progmode”), the system performs a backspace operation 365C. If the “enter” key is pressed 366 and the system is in progmode 366A, the system moves to another display 366B, otherwise it will do nothing.

As shown in FIG. 10I3, the system checks whether start trip is pressed 361 and, if start trip is pressed, it checks whether trip is already in progress 740 (FIG. 10M). Still referring to FIG. 10M, if the trip is already in progress, the system informs the driver that trip data processing is already on 747. If no trip in progress is signaled, it checks whether card is inserted 741, and if the card is inserted properly 742, and if the driver identification from the data card 744 is read properly, the trip can be initiated. If the data card is not inserted promptly or not inserted at all, the driver may be prompted to enter driver identification data 743, and trip may be initiated 746. The system then (referring to FIG. 10I3) checks whether “end trip” key is pressed 362, and if the “end trip” key is pressed 362, the system gets an ending odometer reading from the driver or the vehicle itself and loads the current trip data from the flash memory to the driver's data card 362A. The system then checks whether the “fuel” key is pressed 363, and if the “fuel” key is selected (FIG. 10N), the fuel unit type 750 and amount added 751 is entered. The system then checks whether the fuel type is bulk or retail 752. If the type is retail 753, a currency type is selected 754, and the price (e.g., per unit) 755 and optionally a tax paid or not option 756 are entered.

Configuration Setting Parameters

Referring now to FIG. 10P1, once the vehicle monitoring and reporting system 20 is installed and powered on 800, the registers and buffers are initialized 801 to a default/initial value(s). Moreover, a “power on” message is displayed 802. When a “menu” key is pressed 803, a driver is prompted to enter a password 804. The system then checks whether the password is correct 805. If the password is not correct, the system displays a password error message 806 and prompts a reentering of the password 808. If the password is correct, a vehicle ID entry is prompted 807. After the entry of the vehicle ID, the operator generally presses the “enter” key 809. A driver ID entry is prompted 810. After the driver ID entry, the “enter” key may be pressed 811, and subsequently, the starting odometer entry is prompted 812. After the odometer data is entered, the “enter” key 813 is pressed. A tire diameter entry is prompted 814. After that entry, the “enter” key is pressed 815. A pulse/0.1 mile entry is prompted 816. After that entry, the “enter” key is pressed 817, and a pulse/revolution entry (FIG. 10P2) is prompted 818. After that entry, the “enter” key is pressed 819, and a MWT LOG period entry is prompted 820. After that entry, the driver presses the “enter” key 821, and a pager transmission period entry is prompted 822. After that entry, the “enter” key 823 is pressed, and a communication device no entry is prompted 824. After that entry, the “enter” key is pressed 825, and a data format entry is prompted 826. After that entry, the “enter” key is pressed 827, which prompts a UTC offset entry 828. After that entry, the “enter” key is pressed 829, which prompts a log mode entry 830. After that entry, the “enter” key is pressed 831, and prompts a “stop time detection period” entry 832. After that entry, the enter key is pressed 833.

State Line Detection

Referring now to FIG. 10Q, for state line crossing detection 367, a circle of ambiguity is created with the current position 368. The system compares the nearest state line stored in a state line crossing database 369. The system computes the distance from the current position to the state line 370 and records the current position 371. It then checks whether the current position is closer than previous 372. If the current position is closer than the previous record, the most probable crossing point 374 is predicted. The system then checks whether the state line is within the circle 373. If the state line is not within the circle, it checks whether the new position is in a different state 375. If the new position is in a different state, a line record is created with a position 376.

Tracking on Line

Referring now to FIG. 10R, the tracking signal 835 from communication device/computer 834 is transmitted to the WCTP gateway 836. Then the tracking signal is transmitted to the vehicular subsystem on the vehicle 837. The vehicular subsystem creates a standard record, and that record may be transmitted 838 to one or more customer email addresses 839. Data conversion is made by appropriate software 840 and inserted into the mapping software 841 for vehicle location display 842.

Creating a Scheduled Route

Referring now to FIG. 10S, to create a scheduled route, prior to a trip, a user generally has to input an origin 901 and destination 902 textual address as input into the application software 900, including the route package. Incidentally, this software may be installed one or both in the web and on the client's computer. The software will display the maps with all the reasonable routes to reach the destination 903. If the user confirms a route, the latitude and longitude values on the route with a predetermined distance interval as perhaps 0.1 miles or the end vertices of the road segments and the road bends are generated 904. The scheduled route data generated can be downloaded to the system with the use of a smart card module or through an RS232 communication 905.

Alarm Activation

Referring now to FIG. 10T, an embodiment of the system, which includes an alarm activation feature, receives the current location latitude and longitude values of the vehicle from the GPS receiver for a predetermined period, as every 2 seconds. This location data is compared with the scheduled route data stored in the system 910 described above. If the vehicle deviates from its scheduled route 911, as determined by the system, the system will send a message including current location of the truck's longitude and latitude to a server computer as an e-mail via an appropriate satellite module available in the system 912. The software installed in the server computer will convert the received data to the nearest door number, street name, city and state, and the compiled location address will be sent immediately to the user as e-mail. The software installed at the client's computer will read the e-mail and activate the alarm configured for this purpose 914.

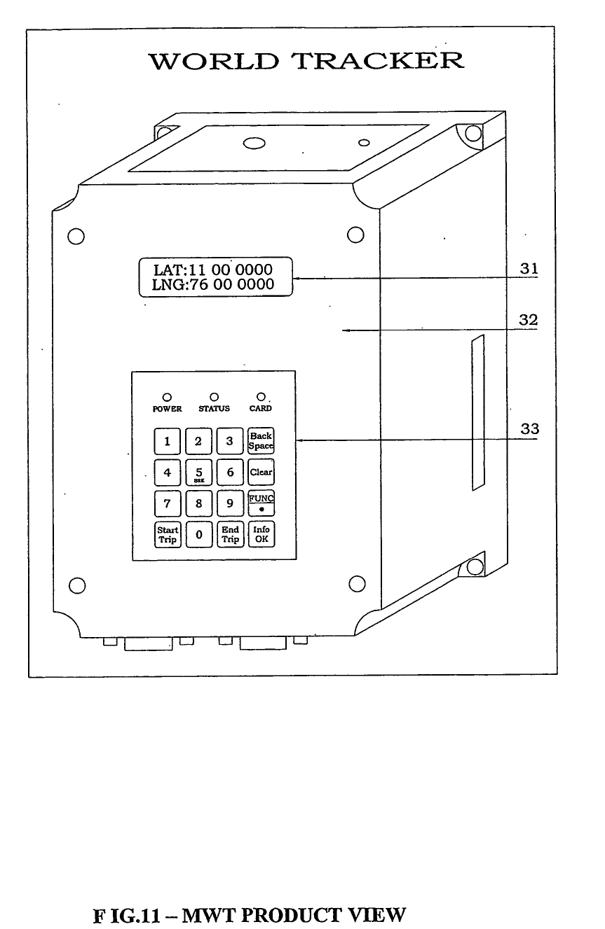

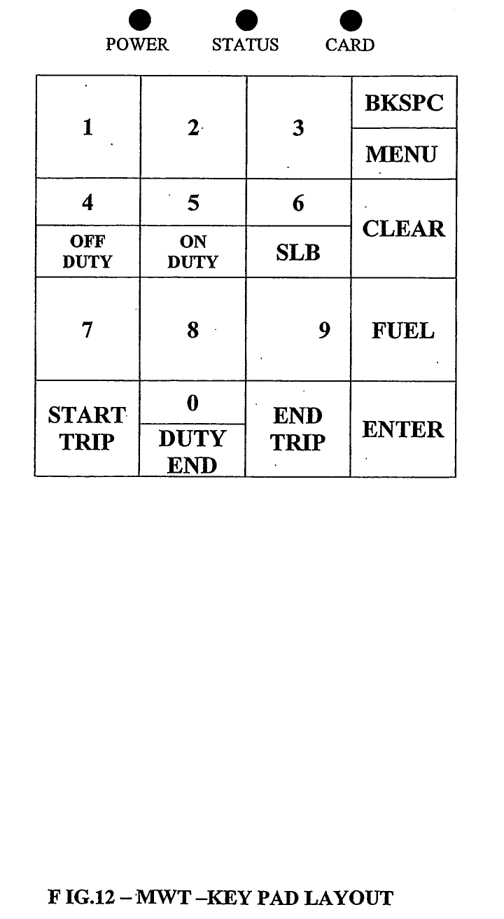

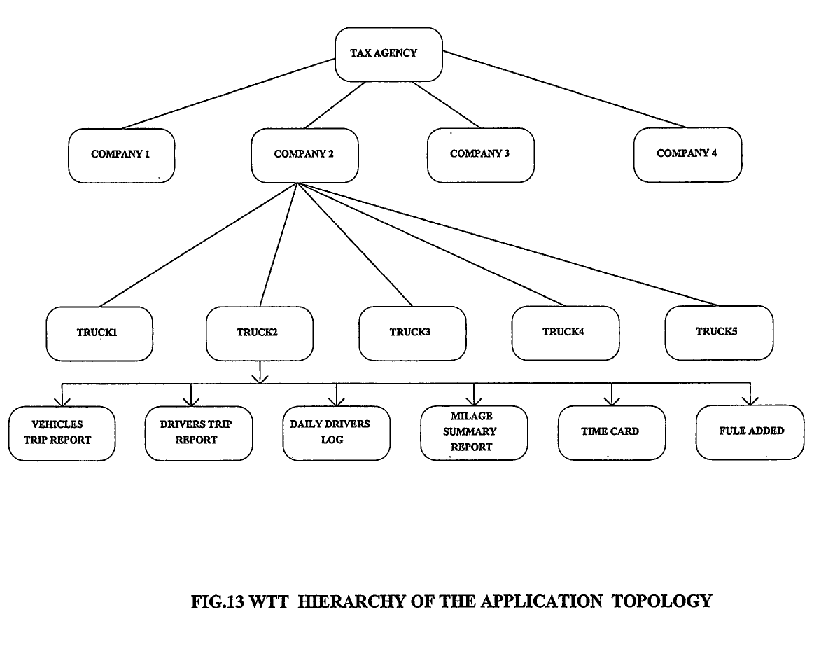

FIG. 11 illustrates the front view of the system with keypad 33 and LCD display 31 units. FIG. 12 shows a magnified front view of the keypad 33 including its function keys. FIG. 13 shows the hierarchy of the application topology for a multi truck system.

This system, when utilized in motor vehicle applications, is capable of monitoring, storing, and transmits data such as the following: driver information, vehicle information, time, speed, latitude and/or longitude of the vehicle, direction of travel, state line crossing data, and mileage. Moreover, the data stored in the unit can be ported to a discretely accessible Internet data storage location either through a pager system for on line tracking or through the unique data card feature of the system. Below are tables indicating exemplary specifications for various components that may be employed by the system.

a) EXEMPLARY SYSTEM OPERATING SPECIFICATIONS:

| | | | |
|---|---|---|---|
| [symbol] . | GPS Module | 2. | Motorola M12 ONCORE |
| [symbol] . | Communication | 4. | Stellar Satellite module/Motorola |
| | Module | | Creata link 2XT for pager |
| [symbol] . | CPU | 6. | Motorola 32 bit embedded |
| | | | controller |
| [symbol] . | Inbuilt Memory | 8. | 1 Mbyte Non volatile memory for |
| | | | trip storage |
| [symbol] . | Data card memory size | 10. | 128 kb (Expandable 1 MB) |
| [symbol] 1. | Data card Interface | 12. | Designed for 128 kb data card |
| | | | (upgradeable) |
| [symbol] 3. | Data card reader/writer | 14. | A stand-alone Mcore controller is |
| | | | used for this Function. |
| [symbol] 5. | Display | 16. | 2 × 16 LED display with LED back |
| | | | light |
| [symbol] 7. | Key board | 18. | 4 × 4 matrix feather touch keypad |
| [symbol] 9. | LED Indications | 20. | Power LED |
| | | 21. | Card LED |
| | | 22. | Status LED |
| [symbol] 3. | Serial port | 24. | RS232 serial port for PC interface |
| | | | for diagnosis purpose and Engine data |
| [symbol] 5. | Parallel I/O | 26. | Optional I/O lines are available at |
| | | | request |
| [symbol] 7. | Power supply | 28. | 9 TO 36 VDC (Pager version) |
| | | | 9 TO 16 v VDC (Satellite version) |
| [symbol] 9. | Data Log Parameters | | Driver ID |
| | | | Driver name |
| | | | License number |
| | | | Vehicle ID |
| | | | Route ID |
| | | | UTC time |
| | | | Stop time |
| | | | Date |
| | | | Latitude |
| | | | Longitude |
| | | | Speed |
| | | | Heading direction |
| | | | GPS fix status |
| | | | GPS status word |
| | | | Mileage |
| | | | Fuel added |
| | | | Price per gallon |
| | | | Type—bulk/retail |
| | | | Starting odo |
| | | | Ending odo |
| | | | Vehicle stopped time |
| | | | Break time |
| | | | Driver hours of service |
| | | | Version |
| [symbol] 0. | Programmable | | Driver ID |
| | parameters | | Driver name |
| | | | Driver license number |
| | | | Driver License State |
| | | | Route ID |
| | | | Fuel added |
| | | | Price per gallon |
| | | | Starting odo |
| | | | Odo ratio |
| | | | Log period |
| | | | Vehicle ID |
| | | | Location ID |
| | | | Ending odo |
| | | | Password |
| | | | UTC offset |
| | | | Pager Number |

b) EXEMPLARY GPS MODULE SPECIFICATION:

| | | | |
|---|---|---|---|
| 48. | I/O Messages | | Latitude, longitude, height, velocity, |
| | | | heading, time |
| | | | Motorola binary protocol at 9600 baud |
| | | | NMEA 0183 at 4800 baud (GGA, GLL, |
| | | | GSA, GSV, RMC, VTG, ZDA) |
| | | | Software selectable output rate (con- |
| | | | tinuous or poll) |
| | | | 3 V digital logic interface |
| | | | Second COM port for RTCM input |
| 49. | Power Requirements | | 2.8 to 3.2 Vdc 50 mVp-p ripple (max) |
| 50. | “Keep-Alive” BATT | 51. | External 1.8 Vdc to 3.2 Vdc, 5 μA |
| | Power | | (typical @2.7 Vdc @ +25° C. |
| 52. | Power consumption | 53. | <0.225 W @ 3 V without antenna |
| 54. | Dimensions | 55. | 40.0 × 60.0 × 10.0 mm (1.57 × 2.36 × |
| | | | 0.39 in.) |
| 56. | Weight | 57. | Receiver 25 g (0.9 oz) |
| 58. | Connectors | | |
| 59. | Power/Data | 60. | 10 pin (2 × 5) unshrouded male header |
| | | | on 0.050 inch centers (available in right |
| | | | angle or straight configuration) |
| 61. | RF | 62. | Right angle MMCX female (subminia- |
| | | | ture snap-on) |
| 63. | Antenna | | Active micro strip patch Antenna |
| | | | Module |
| | | | Powered by Receiver Module at select- |
| | | | able 3 or 5 V |
| 64. | Antenna to Receiver | | Single coaxial cable with 6 db maxi- |
| | Interconnection | | mum loss at L1 (active antenna) |
| | | | Antenna Sense Circuit |
| | | | Antenna gain range 16 to 30 db |
| 65. | Operating Temperature | 66. | −40° C. to +85° C. |
| 67. | Storage Temperature | 68. | −40° C. to +85° C. |
| 69. | Humidity | 70. | 85% Relative Humidity at 85° C. |
| 71. | Altitude | | 18,000 m (60,000 ft.) maximum |
| | | | >18,000 m (60,000 ft.) for velocity |
| | | | <515 m/s (1000 knots) |
| 72. | Standard Features | | Motorola DGPS corrections at 9600 |
| | | | baud on COM port one |
| | | | DGPS Master Site Capability |
| | | | RTCM SC—104 input Type 1 and Type |
| | | | 9 message for DGPS AT 2400, 4800 or |
| | | | 9600 baud on COM port two |
| | | | NMEA 0183 output |
| | | | Inverse DGPS support |
| 73. | Backup | 74. | Lithium battery backup |
| 75. | OPERATING | 76. | |
| | PARAMETERS | | |
| 77. | Power supply | 78. | 9 TO 36 VDC |
| 79. | Operating temperature | 80. | −40° C. TO +85° C. (−40° F. TO |
| | | | +185° F.) |
| 81. | Storage temperature | 82. | −40° C. TO +85° C. (−40° F. TO |
| | | | +185° F.) |
| 83. | Relative humidity | 84. | 0-100% RH |
| 85. | Random Vibration | 86. | 20 to 2000 HZ < 3 grms |
| 87. | Mechanical shock | 88. | 0 to 100 G (using vehicle mounting |
| | | | method) |

c) EXEMPLARY COMMUNICATION MODULE SPECIFICATIONS:
Satellite Module:

| | | |
|---|---|---|
| | General: | 89. |
| | Dimension | 80 × 100 × 20 mm |
| | Weight | 150 gm |
| | VHF RF connector | MCX |
| | DC & Interfacing connector | 40 Pin strip |
| 90. | Power supply: | |
| | Voltage: | |
| | Input Voltage Range | Single input Voltage |
| | | 9-16 V |
| | Current (For 12 V DC input) | |
| | Receive mode | 70 ma |
| | Receive (frame save mode) Mode | 40 ma |
| | Sleep Mode | 2 ma |
| | Off Mode | 0.2 ma |
| | Transmission Mode | 2.5 A |
| | Interfaces: | |
| | Discrete: | |
| | Digital input | 2 ch (3.3 TTL) |
| | Digital Output | 2 ch (3.3 TTL) |
| | On/Off Power control | TTL input control |
| | Status monitor LED's/lines | TBD |
| | Serial: | |
| | Rs232 or TTL | 1 ch |
| | Environmental: | |
| | Operating temperature | From −40 to +85 deg c. |
| | Storage temperature | From −40 to +85 deg c. |
| | EMI & vibration | SAE J1455 |
| | ETSI | TBD |

| | | | |
|---|---|---|---|
| 91. | Coding format | 92. | Reflex 50 |
| 93. | Serial protocol | 94. | CLP or third-party application |
| 95. | Operating temperature | 96. | −40° C. to +85° C. |
| 97. | Interface | 98. | 22-pin vertical shrouded header for |
| | | | combined power supply, serial, and |
| | | | parallel I/O interface. 8-pin vertical |
| | | | shrouded header for JTAG inter- |
| | | | face; SMA connector for antenna |
| 99. | Power supply | 100. | 5-12 Vdc, 2.5 A minimum, 100 |
| | requirements | | mVpp ripple up to 5 MHZ (worst |
| | | | case estimate if sourcing/sinking |
| | | | I/O at max values) |
| 101. | Backup battery/alter- | 102. | 3-9 Vdc, 1 mA if used for RAM |
| | nate transmit power | | backup only. 5-9 Vdc, 1.4 A mini- |
| | supply requirements | | mum, 100 mVpp ripple up to 5 |
| | | | MHZ if used for transmitter supply |
| | | | (battery voltage must be equal to or |
| | | | less than the main supply voltage) |
| 103. | Physical dimensions | 104. | |
| 105. | Length | 106. | 3.75 in (95.25 mm) |
| 107. | Width | 108. | 1.75 in (44.45 mm) |
| 109. | Height | 110. | 0.7 in (17.78 mm) |
| 111. | Weight | 112. | 1.5 oz. (42.5 grams) |
| 113. | Antenna connector | 114. | 50 Ohm SMA female connector |
| 115. | EXEMPLARY | 116. | |
| | TRANSMITTER | | |
| | SPECIFICATION: | | |
| 117. | Frequency | 118. | 901-902 MHZ |
| 119. | RF power output (at | 120. | 0.5 W, 0.75 W, 1.5 W and 2.0 W |
| | antenna port) | | |
| 121. | Transmit data bit rate | 122. | 9600 bits per second (bps) |
| 123. | Modulation | 124. | 4-level Frequency shift keying |
| | | | (FSK) |
| 125. | Frequency stability | 126. | 1 ppm on transmit |
| 127. | EXEMPLARY | | |
| | RECEIVER | | |
| | SPECIFICATIONS: | | |
| 128. | Frequency | 129. | 940-941 MHZ |
| 130. | Sensitivity | 131. | −115 dBms in to SMA antenna |
| | | | connector |
| 132. | Receive data bit rate | 133. | 6400 bps |
| 134. | Modulation | 135. | 4-level FSK |
| 136. | Channel spacing | 137. | 50 KHz |
| 138. | INPUTS/OUTPUTS | | |
| 139. | HVIO-0-HVIO-5 | 140. | 12 Vdc maximum pullup voltage. |
| | (configured as outputs) | 141. | 25 mA maximum sink current |
| | | 142. | (@12 Vdc pull-up) |
| | | 143. | |
| 144. | HVIO-0-HVIO-5 | 145. | 12 Vdc maximum input |
| | (configured as inputs) | | |
| 146. | HVIO-6 & HVIO-7 | 147. | Driven to supply voltage (12 Vdc |
| | (configured as outputs) | | maximum) maximum sourcing/ |
| | | | sinking current is 350 mA |
| 148. | HVIO-6-HVIO-7 | 149. | Maximum input limited to that of |
| | (configured as inputs) | | supply voltage |

Those skilled in the art will now see that certain modifications can be made to the system and related methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

What is claimed is:

1. A vehicle monitoring and reporting system, comprising:
vehicular subsystem comprising a computer, a first data card reader interconnected with said computer, and a plurality of data input devices interconnected with said computer;
a non-vehicular subsystem comprising a central processing unit;
a communication module configured to transmit data between said vehicular and non-vehicular subsystems; and
at least one data card engagable with and readable by said first data card reader.

2. A vehicle monitoring and reporting system, as claimed in claim 1, wherein:
said plurality of data input devices comprises at least one of a GPS receiver, an odometer sensor/electronic control module (ECM), and a manual data input device.

3. A vehicle monitoring and reporting system, as claimed in claim 2, wherein:
said manual data input device comprises at least one of a keyboard, a mouse, a paddle, and a joystick.

4. A vehicle monitoring and reporting system, as claimed in claim 2, wherein:
said plurality of data input devices comprises a GPS receiver, an odometer sensor/electronic control module (ECM), and a manual data input device.

5. A vehicle monitoring and reporting system, as claimed in claim 1, wherein:
said first data card reader comprises a writing feature for writing data to said at least one data card.

6. A vehicle monitoring and reporting system, as claimed in claim 1, wherein:
said non-vehicular subsystem comprises a second data card reader interconnected with said central processing unit.

7. A vehicle monitoring and reporting system, as claimed in claim 1, wherein:
said communication module comprises at least one of a two way pager/GSM system and cellular/satellite communication system.

8. A vehicle monitoring and reporting system, as claimed in claim 1, wherein:
each of said at least one data card comprises vehicle operator-specific data thereon.

9. A vehicle monitoring and reporting system, as claimed in claim 9, wherein:
data from said plurality of data input devices is disposed on said at least one data card.

10. A vehicle monitoring and reporting system, as claimed in claim 9, wherein:
said data card comprises a vehicle operator-specific access code.

11. The system according to claim 9 wherein:
said data card comprises a fuel purchase authorization code.

12. A vehicle monitoring and reporting system, as claimed in claim 1, wherein:
at least one of said vehicular and non-vehicular subsystems is programmed to transmit data to another of said vehicular and non-vehicular subsystems at predetermined intervals.

13. A vehicle monitoring and reporting system, as claimed in claim 1, wherein:
at least one of said vehicular and non-vehicular subsystems is programmed to access data from another of said vehicular and non-vehicular subsystems at predetermined intervals.

14. A vehicle monitoring and reporting system, as claimed in claim 1, wherein:
at least one of said vehicular subsystem, said non-vehicular subsystem, and said at least one data card comprises data indicative of a predetermined route map.

15. A vehicle monitoring and reporting system, as claimed in claim 14, wherein:
at least one of said computer and said central processing unit is programmed to compare said data indicative of a predetermined route map with trip data from said plurality of input devices.

16. A vehicle monitoring and reporting system, as claimed in claim 15, wherein:
at least one of said vehicular and non-vehicular subsystems is programmed to notify a user of a deviation between said data indicative of a predetermined route and said trip data that is beyond a predetermined deviation threshold.

17. A vehicle monitoring and reporting system, as claimed in claim 15, wherein:
at least one of said vehicular and non-vehicular subsystems comprises an audible deviation indicator, wherein said audible deviation indicator is activated upon said deviation.

18. A vehicle monitoring and reporting system, as claimed in claim 1, further comprising:
a website, wherein data from said plurality of data input devices is disposed on said website.

19. A vehicle monitoring and reporting system, as claimed in claim 18, wherein:
data from said at least one data card is disposed on said website.

20. A vehicle monitoring and reporting system, as claimed in claim 18, wherein:
said website comprises data indicative of a predetermined route map.

21. A vehicle monitoring and reporting system, as claimed in claim 20, wherein:
said website comprises means for comparing said data indicative of a predetermined route map with trip data from said plurality of input devices.

22. A vehicle monitoring and reporting system, as claimed in claim 21, wherein:
said website comprises means for notifying a user of a deviation between said data indicative of a predetermined route and said trip data that is beyond a predetermined deviation threshold.

23. A vehicle monitoring and reporting system, as claimed in claim 22, wherein:
said means for notifying comprises a text message generator.

24. A method of using a vehicle monitoring and reporting system, comprising the steps of:
notifying a motor vehicle system of which vehicle operator is operating a motor vehicle, wherein said notifying step comprises electronically accessing data from a vehicle operator-specific data card; and
transmitting data related to at least one of said motor vehicle and said vehicle operator between a vehicular subsystem of said vehicle monitoring and reporting system that is attached to said motor vehicle and a substantially stationary non-vehicular subsystem of the vehicle monitoring and reporting system that is separate and distinct from said vehicular subsystem.

25. A method, as claimed in claim 24, wherein:
said notifying step is accomplished using said vehicular subsystem of said vehicle monitoring and reporting system.

26. A method, as claimed in claim 24, wherein:
said transmitting step occurs at predetermined intervals.

27. A method, as claimed in claim 24, wherein:
said vehicle monitoring and reporting system comprises a plurality of data input devices comprising a GPS receiver, an odometer sensor/electronic control module (ECM), and a manual data input device,
wherein the method further comprises the step of acquiring trip data from at least one of said plurality of data input devices.

28. A method, as claimed in claim 27, wherein:
said transmitting step comprises sending said trip data from said vehicular subsystem to said non-vehicular subsystem.

29. A method, as claimed in claim 27, wherein:
said acquiring step comprises receiving manually input information from said vehicle operator and global positioning information.

30. A method, as claimed in claim 27, wherein:
said acquiring step comprises collecting at least one of locational information and temporal information relating to at least one of said vehicle and said vehicle operator.

31. A method, as claimed in claim 27, wherein:
said trip data of said acquiring step comprises at least one of odometer data, speedometer data, and fuel purchase data.

32. A method, as claimed in claim 27, further comprising:
comparing data indicative of a predetermined route map with said trip data from said plurality of input devices.

33. A method, as claimed in claim 32, further comprising:
alerting a user to a deviation between said data indicative of a predetermined route map and said trip data.

34. A method, as claimed in claim 33, wherein:
said alerting step comprises activating an audible deviation indicator.

35. A method, as claimed in claim 27, further comprising:
disposing said trip data on a website; and
accessing said trip data on said website.

36. A method, as claimed in claim 35, further comprising:
comparing data indicative of a predetermined route map with said trip data from said plurality of input devices.

37. A method, as claimed in claim 36, further comprising:
informing a user of a deviation between said data indicative of a predetermined route and said trip data.

38. A method, as claimed in claim 37, wherein:
said informing step comprises generating a text message.

39. A method, as claimed in claim 38, wherein:
said text message comprises an email message.
